(19) United States
(12) Patent Application Publication
(10) Pub. No.: US 2026/0370854 A1
(43) Pub. Date: Nov. 19, 2026

(54) Adaptive Reference Sample Filtering for Intra Prediction

(71) Applicant: Ofinno, LLC, Reston, VA (US)

(72) Inventors: Médéric Blestel, Bruz (FR); Pierre Jean Andrivon, Liffre (FR)

(73) Assignee: Ofinno, LLC, Reston, VA (US)

(21) Appl. No.: 19/723,283

(22) Filed: Jun. 29, 2026

Related U.S. Application Data
(63) Continuation of application No. PCT/US2024/062064, filed on Dec. 27, 2024.
(60) Provisional application No. 63/615,271, filed on Dec. 27, 2023.

(51) Int. Cl. H04N 19/176; H04N 19/105; H04N 19/117; H04N 19/159; H04N 19/46; H04N 19/593; H04N 19/82

(52) U.S. Cl. CPC H04N 19/176; H04N 19/105; H04N 19/117; H04N 19/159; H04N 19/46; H04N 19/593; H04N 19/82

(57) ABSTRACT

A video coder, such as an encoder or a decoder, may generate a first buffer comprising unfiltered reference samples obtained from reference samples of a reference template of a current block. The video coder may generate a second buffer comprising filtered reference samples obtained by filtering the reference samples. For each intra prediction mode (IPM) of a plurality of IPMs selected to generate a blended prediction block for the current block, the video coder may select, based on the IPM, a buffer from the first buffer and the second buffer, and generate a respective prediction block for the current block based on the IPM and the selected buffer. The video coder may blend the plurality of prediction blocks to generate the blended prediction block and code the current block using the blended prediction block.

### CROSS-REFERENCE TO RELATED APPLICATIONS

This application is a continuation of International Application No. PCT/US2024/062064, filed Dec. 27, 2024, which claims the benefit of U.S. Provisional Application No. 63/615,271, filed Dec. 27, 2023, all of which are hereby incorporated by reference in their entireties.

### BRIEF DESCRIPTION OF THE DRAWINGS

Some features are shown by way of example, and not by limitation, in the accompanying drawings. In the drawings, like numerals reference similar elements.

FIG. 1 shows an example video coding/decoding system in which embodiments of the present disclosure may be implemented.

FIG. 2 shows an example encoder in which embodiments of the present disclosure may be implemented.

FIG. 3 shows an example decoder in which embodiments of the present disclosure may be implemented.

FIG. 4 shows an example quadtree partitioning of a coding tree block (CTB).

FIG. 5 shows an example quadtree corresponding to the example quadtree partitioning of the CTB in FIG. 4.

FIG. 6 shows examples of binary tree and ternary tree partitions.

FIG. 7 shows an example of combined quadtree and multi-type tree partitioning of a CTB.

FIG. 8 shows an example tree corresponding to the combined quadtree and multi-type tree partitioning of the CTB shown in FIG. 7.

FIG. 9 shows an example set of reference samples determined for intra prediction of a current block.

FIGS. 10A, 10B, and 10C show example intra prediction modes.

FIG. 11 shows an example of a current block and corresponding reference samples.

FIG. 12 shows an example of applying an intra prediction mode (e.g., an angular mode) for prediction of a current block.

FIG. 13A shows an example of inter prediction performed for a current block in a current picture.

FIG. 13B shows an example motion vector.

FIG. 14 shows an example of bi-prediction performed for a current block.

FIG. 15A shows example spatial candidate neighboring blocks relative to a current block being coded.

FIG. 15B shows example locations of two temporal, co-located blocks relative to a current block.

FIG. 16 shows an example of intra block copy (IBC).

FIG. 17 shows an example of intra template matching search areas for IntraTMP mode, according to some embodiments.

FIG. 18 shows an example of decoder-side intra mode derivation (DIMD) template zone for computing a histogram of gradients (HoG), according to some embodiments.

FIG. 19 shows a flowchart of an example process for DIMD predictor derivation, according to some embodiments.

FIG. 20 shows an example prediction fusion by combining two HoG modes and a planar mode, according to some embodiments.

FIG. 21 shows an example of template-based intra mode derivation (TIMD) for coding a current block, according to some embodiments.

FIG. 22 shows a flowchart of an example process for TIMD predictor generation, according to some embodiments.

FIG. 23 shows a flowchart of a method for predicting samples of a current block using an intra prediction mode, according to some embodiments.

FIG. 24 shows a flowchart of an example method for generating a plurality of selected intra prediction modes to determine a DIMD predictor for predicting samples of a current block, according to some embodiments.

FIG. 25 shows a flowchart of an example method for generating a TIMD predictor including one or more selected TIMD modes, according to some embodiments.

FIG. 26 shows a flowchart of an example method for encoding or decoding a current block with a DIMD-based or TIMD-based mode, according to some embodiments.

FIG. 27 shows a flowchart of an example method for encoding or decoding a current block with a DIMD-based or TIMD-based mode, according to some embodiments.

FIG. 28 shows a flowchart of an example method for encoding or decoding a current block with a DIMD-based or TIMD-based mode, according to some embodiments.

FIG. 29 shows a block diagram of an example computer system in which embodiments of the present disclosure may be implemented.

### DETAILED DESCRIPTION

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

A video sequence, comprising multiple pictures/frames, may be represented in digital form for storage and/or transmission. Representing a video sequence in digital form may require a large quantity of bits. Large data sizes that may be associated with video sequences may require significant resources for storage and/or transmission. Video encoding may be used to compress a size of a video sequence for more efficient storage and/or transmission. Video decoding may be used to decompress a compressed video sequence for display and/or other forms of consumption.

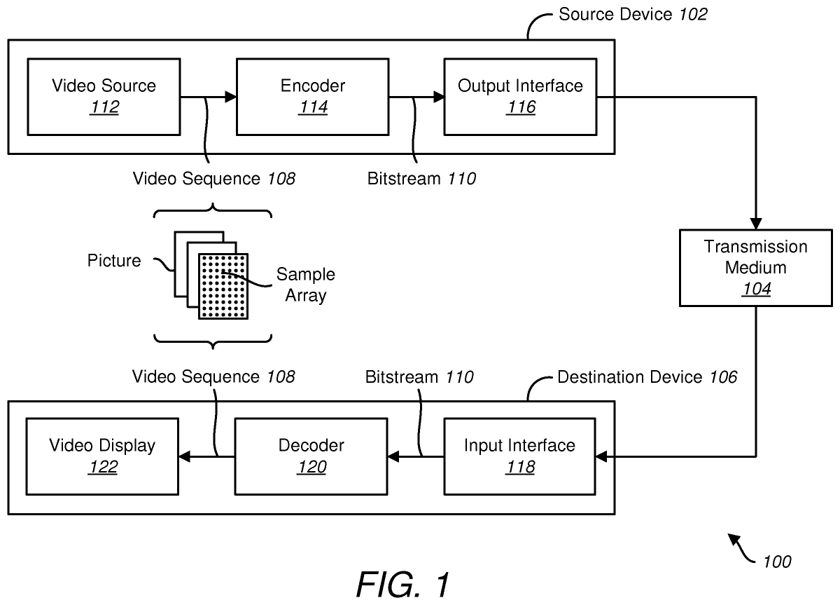

FIG. 1 shows an example video coding/decoding system 100 in which embodiments of the present disclosure may be implemented. Video coding/decoding system 100 comprises a source device 102, a transmission medium 104, and a destination device 106. Source device 102 encodes a video sequence 108 into a bitstream 110 for more efficient storage and/or transmission. Source device 102 may store and/or send/transmit bitstream 110 to destination device 106 via transmission medium 104. Destination device 106 decodes bitstream 110 to display video sequence 108. Destination device 106 may receive bitstream 110 from source device 102 via transmission medium 104. Source device 102 and/or destination device 106 may be any of a plurality of different devices (e.g., a desktop computer, laptop computer, tablet computer, smart phone, wearable device, television, camera, video gaming console, set-top box, video streaming device, etc.).

Source device 102 may comprise (e.g., for encoding video sequence 108 into bitstream 110) one or more of a video source 112, an encoder 114, and/or an output interface 116. Video source 112 may provide and/or generate video sequence 108 based on a capture of a natural scene and/or a synthetically generated scene. A synthetically generated scene may be a scene comprising computer generated graphics and/or screen content. Video source 112 may comprise a video capture device (e.g., a video camera), a video archive comprising previously captured natural scenes and/or synthetically generated scenes, a video feed interface to receive captured natural scenes and/or synthetically generated scenes from a video content provider, and/or a processor to generate synthetic scenes.

A video sequence, such as video sequence 108, may comprise a series of pictures (also referred to as frames). A video sequence may achieve an impression of motion based on successive presentation of pictures of the video sequence using a constant time interval or variable time intervals between the pictures. A picture may comprise one or more sample arrays of intensity values. The intensity values may be taken (e.g., measured, determined, provided) at a series of regularly spaced locations within a picture. A color picture may comprise (e.g., typically comprises) a luminance sample array and two chrominance sample arrays. The luminance sample array may comprise intensity values representing the brightness (e.g., luma component, Y) of a picture. The chrominance sample arrays may comprise intensity values that respectively represent the blue and red components of a picture (e.g., chroma components, Cb and Cr) separate from the brightness. Other color picture sample arrays may be possible based on different color schemes (e.g., a red, green, blue (RGB) color scheme). A pixel, in a color picture, may refer to/comprise/be associated with all intensity values (e.g., luma component, chroma components), for a given location, in the sample arrays (e.g., three sample arrays are used for one luma component and two chroma components, respectively) used to represent color pictures. A monochrome picture may comprise a single, luminance sample array. A pixel, in a monochrome picture, may refer to/comprise/be associated with the intensity value (e.g., luma component) at a given location in the single, luminance sample array used to represent monochrome pictures.

Encoder 114 may encode video sequence 108 into bitstream 110. Encoder 114 may apply/use (e.g., to encode video sequence 108) one or more prediction techniques to reduce redundant information in video sequence 108. Redundant information is information that may be predicted at a decoder and need not be transmitted to the decoder for accurate decoding of video sequence 108. For example, encoder 114 may apply spatial prediction (e.g., intra-frame or intra prediction), temporal prediction (e.g., inter-frame prediction or inter prediction), inter-layer prediction, and/or other prediction techniques to reduce redundant information in video sequence 108. Encoder 114 may partition pictures comprising video sequence 108 into rectangular regions referred to as blocks, for example, before applying one or more prediction techniques. Encoder 114 may then encode a block using the one or more of the prediction techniques.

For temporal prediction, encoder 114 may search for a block similar to the block being encoded in another picture (e.g., referred to as a reference picture) of video sequence 108. The block determined during the search (e.g., referred to as a prediction block) may then be used to predict the block being encoded. For spatial prediction, encoder 114 may form a prediction block based on data from reconstructed neighboring samples of the block to be encoded within the same picture of video sequence 108. A reconstructed sample refers to a sample that was encoded and then decoded. Encoder 114 may determine a prediction error (e.g., also referred to as a residual) based on the difference between a block being encoded and a prediction block. The prediction error may represent non-redundant information that may be sent/transmitted to a decoder for accurate decoding of video sequence 108.

Encoder 114 may apply a transform to the prediction error (e.g. using a discrete cosine transform (DCT), or any other transform) to generate transform coefficients. Encoder 114 may form bitstream 110 based on the transform coefficients and other information used to determine prediction blocks using/based on prediction types, motion vectors, and/or prediction modes. Encoder 114 may perform one or more of quantization and entropy coding of the transform coefficients and/or the other information used to determine the prediction blocks, for example, before forming bitstream 110. The quantization and/or the entropy coding may further reduce the quantity of bits needed to store and/or transmit video sequence 108.

Output interface 116 may be configured to write and/or store bitstream 110 onto transmission medium 104 for transmission to destination device 106. In addition or alternatively, output interface 116 may be configured to send/transmit, upload, and/or stream bitstream 110 to destination device 106 via transmission medium 104. Output interface 116 may comprise a wired and/or a wireless transmitter configured to send/transmit, upload, and/or stream bitstream 110 in accordance with one or more proprietary, open-source, and/or standardized communication protocols (e.g., Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, Wireless Application Protocol (WAP) standards, and/or any other communication protocol).

Transmission medium 104 may comprise wireless, wired, and/or computer readable medium. For example, transmission medium 104 may comprise one or more wires, cables, air interfaces, optical discs, flash memory, and/or magnetic memory. In addition or alternatively, transmission medium 104 may comprise one or more networks (e.g., the internet) or file servers configured to store and/or send/transmit encoded video data.

Destination device 106 may decode bitstream 110 into video sequence 108 for display. Destination device 106 may comprise one or more of an input interface 118, a decoder 120, and/or a video display 122. Input interface 118 may be configured to read bitstream 110 stored on transmission medium 104 by source device 102. In addition or alternatively, input interface 118 may be configured to receive, download, and/or stream bitstream 110 from source device 102 via transmission medium 104. Input interface 118 may comprise a wired and/or a wireless receiver configured to receive, download, and/or stream bitstream 110 in accordance with one or more proprietary, open-source, standardized communication protocols, and/or any other communication protocol (e.g., such as referenced herein).

Decoder 120 may decode video sequence 108 from encoded bitstream 110. The decoder 120 may generate prediction blocks for pictures of video sequence 108 in a similar manner as encoder 114 and determine the prediction errors for the blocks, for example, to decode video sequence 108. Decoder 120 may generate the prediction blocks using/based on prediction types, prediction modes, and/or motion vectors received in bitstream 110. Decoder 120 may determine the prediction errors using the transform coefficients received in bitstream 110. Decoder 120 may determine the prediction errors by weighting transform basis functions using the transform coefficients. Decoder 120 may combine the prediction blocks and the prediction errors to decode video sequence 108. Video sequence 108 at the destination device 106 may be, or may not necessarily be, the same video sequence sent, such as video sequence 108 as sent by the source device 102. Decoder 120 may decode a video sequence that approximates video sequence 108, for example, because of lossy compression of video sequence 108 by encoder 114 and/or errors introduced into encoded bitstream 110 during transmission to destination device 106.

Video display 122 may display video sequence 108 to a user. Video display 122 may comprise a cathode ray tube (CRT) display, a liquid crystal display (LCD), a plasma display, a light emitting diode (LED) display, and/or any other display device suitable for displaying video sequence 108.

Video coding/decoding system 100 is merely an example and video encoding/decoding systems different from the video coding/decoding system 100 and/or modified versions of the video coding/decoding system 100 may similarly perform the methods and processes as described herein. For example, the video coding/decoding system 100 may comprise other components and/or arrangements. For example, video source 112 may be external to source device 102. Similarly, video display 122 may be external to destination device 106 or omitted altogether (e.g., if video sequence 108 is intended for consumption by a machine and/or storage device). In an example, source device 102 may further comprise a video decoder and destination device 106 may further comprise a video encoder. For example, source device 102 may be configured to further receive an encoded bitstream from destination device 106 to support two-way video transmission between the devices.

Encoder 114 and/or decoder 120 may operate according to one or more proprietary or industry video coding standards. For example, encoder 114 and/or decoder 120 may operate in accordance with one or more proprietary, open-source, and/or standardized protocols (e.g., International Telecommunications Union Telecommunication Standardization Sector (ITU-T) H.263, ITU-T H.264 and Moving Picture Experts Group (MPEG)-4 Visual (also known as Advanced Video Coding (AVC)), ITU-T H.265 and MPEG-H Part 2 (also known as High Efficiency Video Coding (HEVC)), ITU-T H.266 and MPEG-I Part 3 (also known as Versatile Video Coding (VVC)), the WebM VP8 and VP9 codecs, and/or AOMedia Video 1 (AV1), and/or any other video coding protocol).

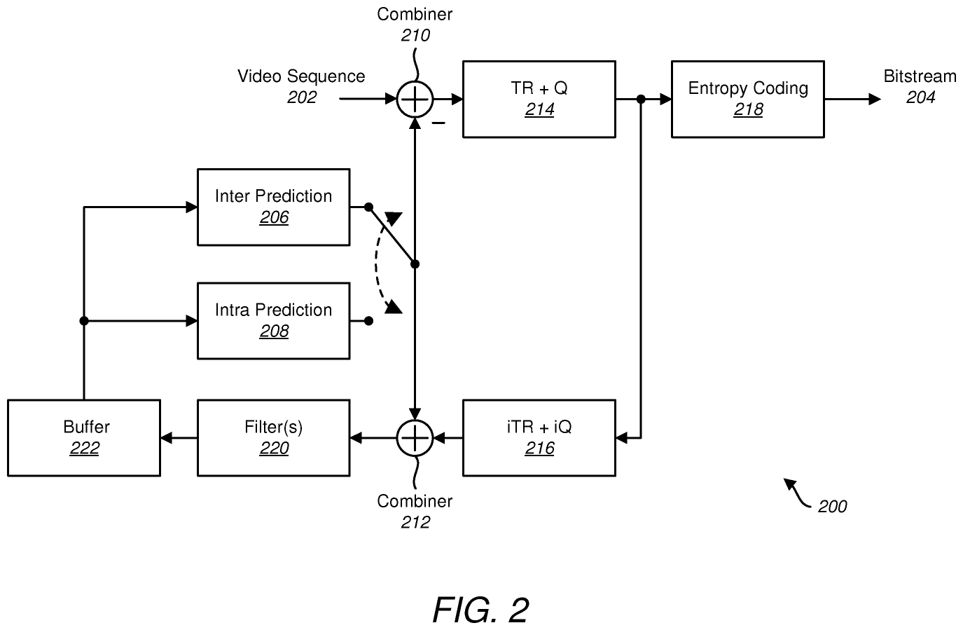

FIG. 2 shows an example encoder. Encoder 200 as shown in FIG. 2 may implement one or more processes described herein. Encoder 200 may encode a video sequence 202 into a bitstream 204 for more efficient storage and/or transmission. Encoder 200 may be implemented in video coding/decoding system 100 as shown in FIG. 1 (e.g., as encoder 114) or in any computing, communication, or electronic device (e.g., desktop computer, laptop computer, tablet computer, smart phone, wearable device, television, camera, video gaming console, set-top box, video streaming device, etc.). Encoder 200 may comprise one or more of an inter prediction unit 206, an intra prediction unit 208, combiners 210 and 212, a transform and quantization unit (TR+Q) 214, an inverse transform and quantization unit (iTR+iQ) 216, an entropy coding unit 218, one or more filters 220, and/or a buffer 222.

Encoder 200 may partition pictures (e.g., frames) of (e.g., comprising) video sequence 202 into blocks and encode video sequence 202 on a block-by-block basis. Encoder 200 may perform/apply a prediction technique on a block being encoded using either inter prediction unit 206 or intra prediction unit 208. Inter prediction unit 206 may perform inter prediction by searching for a block similar to the block being encoded in another, reconstructed picture (e.g., a reference picture) of video sequence 202. A reconstructed picture refers to a picture that was encoded and then decoded. The block determined during the search (e.g., referred to as a prediction block) may then be used to predict the block being encoded to remove redundant information. Inter prediction unit 206 may exploit temporal redundancy or similarities in scene content from picture to picture in video sequence 202 to determine the prediction block. For example, scene content between pictures of video sequence 202 may be similar except for differences due to motion and/or affine transformation of the screen content over time.

Intra prediction unit 208 may perform intra prediction by forming a prediction block based on data from reconstructed neighboring samples of the block to be encoded within the same picture of video sequence 202. A reconstructed sample refers to a sample that was encoded and then decoded. Intra prediction unit 208 may exploit spatial redundancy or similarities in scene content within a picture of video sequence 202 to determine the prediction block. For example, the texture of a region of scene content in a picture may be similar to the texture in the immediate surrounding area of the region of the scene content in the same picture.

Combiner 210 may determine a prediction error (e.g., referred to as a residual) based on the difference between the block being encoded and the prediction block. The prediction error may represent non-redundant information that may be sent/transmitted to a decoder for accurate decoding of video sequence 202.

Transform and quantization unit (TR+Q) 214 may transform and quantize the prediction error. Transform and quantization unit 214 may transform the prediction error into transform coefficients by applying, for example, a DCT to reduce correlated information in the prediction error. Transform and quantization unit 214 may quantize the coefficients by mapping data of the transform coefficients to a predefined set of representative values. Transform and quantization unit 214 may quantize the coefficients to reduce irrelevant information in bitstream 204. The irrelevant information refers to information that may be removed from the coefficients without producing visible and/or perceptible distortion in video sequence 202 after decoding (e.g., at a receiving device).

Entropy coding unit 218 may apply one or more entropy coding methods to the quantized transform coefficients to further reduce the bit rate. For example, entropy coding unit 218 may apply context adaptive variable length coding (CAVLC), context adaptive binary arithmetic coding (CABAC), and/or syntax-based context-based binary arithmetic coding (SBAC). The entropy coded coefficients may be packed to form bitstream 204.

Inverse transform and quantization unit (iTR+iQ) 216 may inverse quantize and inverse transform the quantized transform coefficients to determine a reconstructed prediction error. Combiner 212 may combine the reconstructed prediction error with the prediction block to form a reconstructed block. Filter(s) 220 may filter the reconstructed block, for example, using a deblocking filter and/or a sample-adaptive offset (SAO) filter. Buffer 222 may store the reconstructed block for prediction of one or more other blocks in the same and/or different picture of video sequence 202.

Encoder 200 may further comprise an encoder control unit. The encoder control unit may be configured to control one or more units of encoder 200 as shown in FIG. 2. The encoder control unit may control the one or more units of encoder 200 such that bitstream 204 may be generated in conformance with the requirements of one or more proprietary coding protocols, industry video coding standards, and/or any other video coding protocol. For example, the encoder control unit may control the one or more units of encoder 200 such that bitstream 204 may be generated in conformance with one or more of ITU-T H.263, AVC, HEVC, VVC, VP8, VP9, AV1, and/or any other video coding standard/format.

The encoder control unit may be configured to attempt to minimize (or reduce) the bitrate of bitstream 204 and/or maximize (or increase) the reconstructed video quality (e.g., within the constraints of a proprietary coding protocol, industry video coding standard, and/or any other video coding protocol). For example, the encoder control unit may be configured to attempt to minimize or reduce the bitrate of bitstream 204 such that the reconstructed video quality does not fall below a certain level/threshold, and/or to maximize or increase the reconstructed video quality such that the bitrate of bitstream 204 does not exceed a certain level/threshold. The encoder control unit may determine/control one or more of: partitioning of the pictures of video sequence 202 into blocks, whether a block is inter predicted by inter prediction unit 206 or intra predicted by intra prediction unit 208, a motion vector for inter prediction of a block, an intra prediction mode among a plurality of intra prediction modes for intra prediction of a block, filtering performed by filter(s) 220, and/or one or more transform types and/or quantization parameters applied by transform and quantization unit 214. The encoder control unit may determine/control one or more of the above based on a rate-distortion measure for a block or picture being encoded. The encoder control unit may determine/control one or more of the above to reduce the rate-distortion measure for a block or picture being encoded.

The prediction type used to encode a block (intra or inter prediction), prediction information of the block (intra prediction mode if intra predicted, motion vector, etc.), and/or transform and/or quantization parameters, may be sent to entropy coding unit 218 to be further compressed (e.g., to reduce the bitrate). For example, entropy coding unit 218 may apply context adaptive variable length coding (CAVLC), context adaptive binary arithmetic coding (CABAC), and/or syntax-based context-based binary arithmetic coding (SBAC) to achieve further compression. The prediction type, prediction information, and/or transform and/or quantization parameters may be packed with the prediction error to form bitstream 204.

Encoder 200 is merely an example and encoders different from encoder 200 and/or modified versions of encoder 200 may perform the methods and processes as described herein. For example, encoder 200 may comprise other components and/or arrangements. One or more of the components shown in FIG. 2 may be optionally included in encoder 200 (e.g., entropy coding unit 218 and/or filters(s) 220).

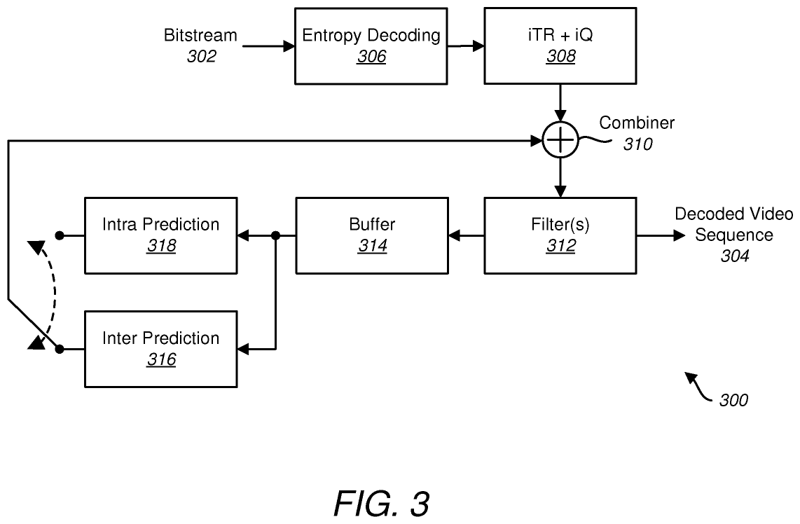

FIG. 3 shows an example decoder. A decoder 300 as shown in FIG. 3 may implement one or more processes described herein. Decoder 300 may decode a bitstream 302 into a decoded video sequence 304 for display and/or some other form of consumption. Decoder 300 may be implemented in video coding/decoding system 100 in FIG. 1 and/or in a computing, communication, or electronic device (e.g., desktop computer, laptop computer, tablet computer, smart phone, wearable device, television, camera, video gaming console, set-top box, and/or video streaming device). Decoder 300 may comprise an entropy decoding unit 306, an inverse transform and quantization (iTR+iQ) unit 308, a combiner 310, one or more filters 312, a buffer 314, an inter prediction unit 316, and/or an intra prediction unit 318.

Decoder 300 may comprise a decoder control unit configured to control one or more units of decoder 300. The decoder control unit may control the one or more units of decoder 300 such that bitstream 302 is decoded in conformance with the requirements of one or more proprietary coding protocols, industry video coding standards, and/or any other communication protocol. For example, the decoder control unit may control the one or more units of decoder 300 such that the bitstream 302 is decoded in conformance with one or more of ITU-T H.263, AVC, HEVC, VVC, VP8, VP9, AV1, and/or any other video coding standard/format.

The decoder control unit may determine/control one or more of: whether a block is inter predicted by inter prediction unit 316 or intra predicted by intra prediction unit 318, a motion vector for inter prediction of a block, an intra prediction mode among a plurality of intra prediction modes for intra prediction of a block, filtering performed by filter(s) 312, and/or one or more inverse transform types and/or inverse quantization parameters to be applied by inverse transform and quantization unit 308. One or more of the control parameters used by the decoder control unit may be packed in bitstream 302.

Entropy decoding unit 306 may entropy decode the bitstream 302. For example, entropy decoding unit 306 may apply context adaptive variable length coding (CAVLC), context adaptive binary arithmetic coding (CABAC), and syntax-based context-based binary arithmetic coding (SBAC) to decompress the prediction type used to encode a block (intra or inter prediction), prediction information of the block (intra prediction mode if intra predicted, motion vector, etc.), and transform and quantization parameters. Inverse transform and quantization unit 308 may inverse quantize and/or inverse transform the quantized transform coefficients to determine a decoded prediction error. Combiner 310 may combine the decoded prediction error with a prediction block to form a decoded block. The prediction block may be generated by intra prediction unit 318 or inter prediction unit 316 (e.g., as described above with respect to encoder 200 in FIG. 2). Filter(s) 312 may filter the decoded block, for example, using a deblocking filter and/or a sample-adaptive offset (SAO) filter. Buffer 314 may store the decoded block for prediction of one or more other blocks in the same and/or different picture of the video sequence in bitstream 302. Decoded video sequence 304 may be output from filter(s) 312 as shown in FIG. 3.

Decoder 300 is merely an example and decoders different from decoder 300 and/or modified versions of decoder 300 may perform the methods and processes as described herein. For example, decoder 300 may have other components and/or arrangements. One or more of the components shown in FIG. 3 may be optionally included in decoder 300 (e.g., entropy decoding unit 306 and/or filters(s) 312).

Although not shown in FIGS. 2 and 3, each of encoder 200 and decoder 300 may further comprise an intra block copy unit in addition to inter prediction and intra prediction units. The intra block copy unit may perform/operate similar to an inter prediction unit but may predict blocks within the same picture. For example, the intra block copy unit may exploit repeated patterns that appear in screen content. The screen content may include computer generated text, graphics, animation, etc.

Video encoding and/or decoding may be performed on a block-by-block basis. The process of partitioning a picture into blocks may be adaptive based on the content of the picture. For example, larger block partitions may be used in areas of a picture with higher levels of homogeneity to improve coding efficiency.

A picture (e.g., in HEVC, or any other coding standard/format) may be partitioned into non-overlapping square blocks, which may be referred to as coding tree blocks (CTBs). The CTBs may comprise samples of a sample array. A CTB may have a size of 2nx2n samples, where n may be specified by a parameter of the encoding system. For example, n may be 4, 5, 6, or any other value. A CTB may have any other size. A CTB may be further partitioned by a recursive quadtree partitioning into coding blocks (CBs) of half vertical and half horizontal size. The CTB may form the root of the quadtree. A CB that is not split further as part of the recursive quadtree partitioning may be referred to as a leaf CB of the quadtree, and otherwise may be referred to as a non-leaf CB of the quadtree. A CB may have a minimum size specified by a parameter of the encoding system. For example, a CB may have a minimum size of 4×4, 8×8, 16×16, 32×32, 64×64 samples, or any other minimum size. A CB may be further partitioned into one or more prediction blocks (PBs) for performing inter and/or intra prediction. A PB may be a rectangular block of samples on which the same prediction type/mode may be applied. A CB may also be further partitioned into intra sub-partitions (ISP) where the reconstructed samples of each sub-partition are available to generate the prediction of the next sub-partition. For example, a CB may be split into 2 to 4 sub-partitions. For transformations, a CB may be partitioned into one or more transform blocks (TBs). A TB may be a rectangular block of samples that may determine/indicate an applied transform size.

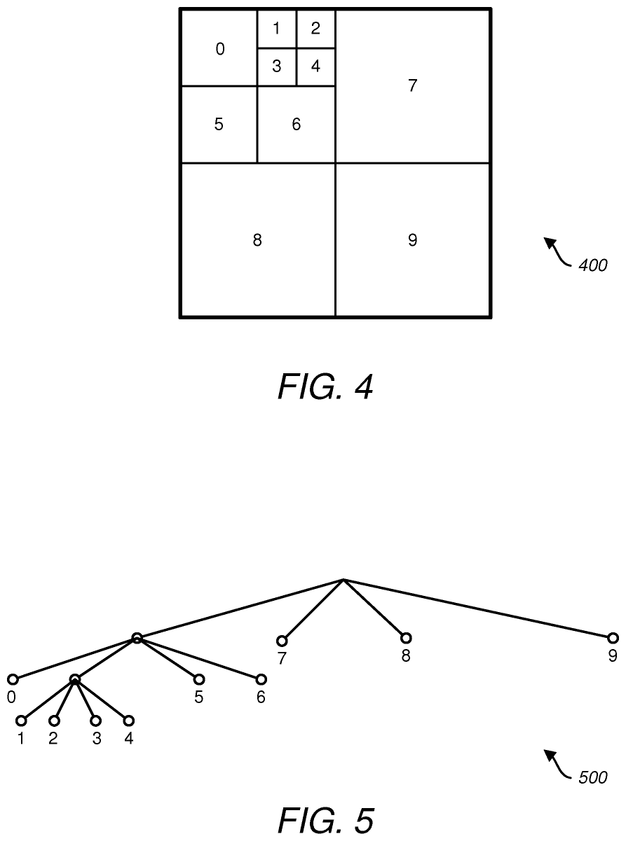

FIG. 4 shows an example quadtree partitioning of a CTB 400. FIG. 5 shows an example quadtree 500 corresponding to the example quadtree partitioning of CTB 400 in FIG. 4. As shown in the examples of FIGS. 4 and 5, CTB 400 may first be partitioned into four CBs of half vertical and half horizontal size. Three of the resulting CBs of the first level partitioning of CTB 400 are leaf CBs. The three leaf CBs of the first level partitioning of CTB 400 are respectively labeled 7, 8, and 9 in FIGS. 4 and 5. The non-leaf CB of the first level partitioning of CTB 400 is partitioned into four sub-CBs of half vertical and half horizontal size. Three of the resulting sub-CBs of the second level partitioning of CTB 400 are leaf CBs. The three leaf CBs of the second level partitioning of CTB 400 are respectively labeled 0, 5, and 6 in FIGS. 4 and 5. Finally, the non-leaf CB of the second level partitioning of CTB 400 is partitioned into four leaf CBs of half vertical and half horizontal size. The four leaf CBs are respectively labeled 1, 2, 3, and 4 in FIGS. 4 and 5.

The example CTB 400 of FIG. 4 is partitioned into 10 leaf CBs respectively labeled 0-9, but may be partitioned into other quantities of leaf CBs. The 10 leaf CBs may correspond to 10 CB leaf nodes (e.g., 10 CB leaf nodes of quadtree 500 as shown in FIG. 5). In other examples, a CTB may be partitioned into a different number of leaf CBs. The resulting quadtree partitioning of CTB 400 may be scanned using a z-scan (e.g., left-to-right, top-to-bottom) to form the sequence order for encoding/decoding the CB leaf nodes. A numeric label (e.g., indicator, index) of each CB leaf node in FIGS. 4 and 5 may correspond to the sequence order for encoding/decoding. For example, CB leaf node 0 may be encoded/decoded first and CB leaf node 9 may be encoded/decoded last. Although not shown in FIGS. 4 and 5, each CB leaf node may comprise one or more PBs and/or TBs.

A picture, in VVC (or in any other coding standard/format), may be partitioned in a similar manner (such as in HEVC). A picture may be first partitioned into non-overlapping square CTBs. The CTBs may then be partitioned, using a recursive quadtree partitioning, into CBs of half vertical and half horizontal size. A quadtree leaf node (e.g., in VVC) may be further partitioned by a binary tree or ternary tree partitioning (or any other partitioning) into CBs of unequal sizes.

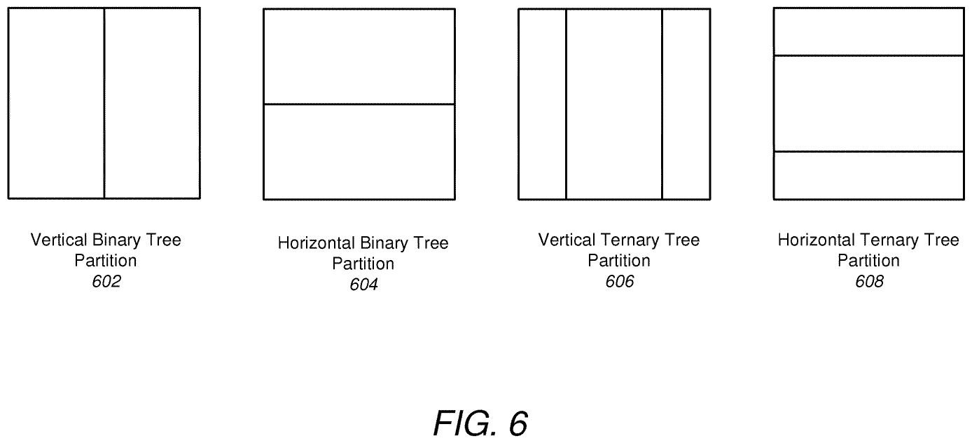

FIG. 6 shows example binary tree and ternary tree partitions. A binary tree partition may divide a parent block in half in either a vertical direction 602 or a horizontal direction 604. The resulting partitions may be half in size as compared to the parent block. In other examples, the resulting partitions may correspond to sizes that are less than and/or greater than half of the parent block size. A ternary tree partition may divide a parent block into three parts in either a vertical direction 606 or a horizontal direction 608. FIG. 6 shows an example in which the middle partition may be twice as large as the other two end partitions in the ternary tree partitions. In other examples, partitions may be of other sizes relative to each other and to the parent block. Binary and ternary tree partitions are examples of multi-type tree partitioning. Multi-type tree partitions may comprise partitioning a parent block into other quantities of smaller blocks. The block partitioning strategy (e.g., in VVC) may be referred to as a combination of quadtree and multi-type tree partitioning (quadtree+multi-type tree partitioning) because of the addition of binary and/or ternary tree partitioning to quadtree partitioning.

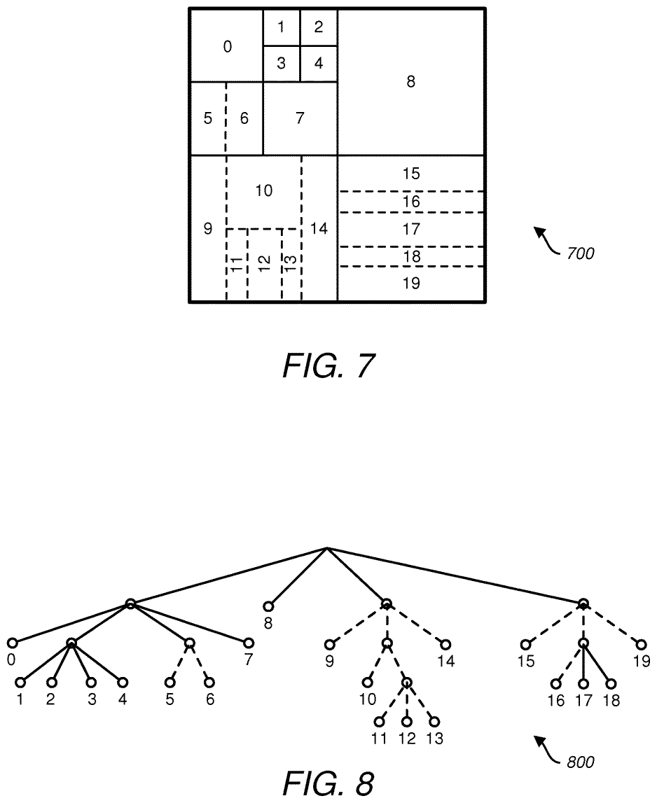

FIG. 7 shows an example of combined quadtree and multi-type tree partitioning of a CTB 700. FIG. 8 shows an example tree 800 corresponding to the combined quadtree and multi-type tree partitioning of CTB 700 shown in FIG. 7. In both FIGS. 7 and 8, quadtree splits are shown in solid lines and multi-type tree splits are shown in dashed lines. For ease of explanation, CTB 700 is shown with the same quadtree partitioning as the CTB 400 described in FIG. 4, and a description of the quadtree partitioning of CTB 700, which is similar to that for CTB 400, is omitted. The quadtree partitioning of the CTB 700 is merely an example and a CTB may be quadtree partitioned in a manner different from the CTB 700. Additional multi-type tree partitions of CTB 700 may be made relative to three leaf CBs shown in FIG. 4. The three leaf CBs in FIG. 4 that are shown in FIG. 7 as being further partitioned may be leaf CBs 5, 8, and 9. The three leaf CBs may be further partitioned using one or more binary and/or ternary tree partitions.

The leaf CB 5 of FIG. 4 may be partitioned into two CBs based on a vertical binary tree partitioning. The two resulting CBs may be leaf CBs respectively labeled 5 and 6 in FIGS. 7 and 8. The leaf CB 8 of FIG. 4 may be partitioned into three CBs based on a vertical ternary tree partition. Two of the three resulting CBs may be leaf CBs respectively labeled 9 and 14 in FIGS. 7 and 8. The remaining, non-leaf CB may be partitioned first into two CBs based on a horizontal binary tree partition. One of the two CBs may be a leaf CB labeled 10. The other of the two CBs may be further partitioned into three CBs based on a vertical ternary tree partition. The resulting three CBs may be leaf CBs respectively labeled 11, 12, and 13 in FIGS. 7 and 8. The leaf CB 9 of FIG. 4 may be partitioned into three CBs based on a horizontal ternary tree partition. Two of the three CBs may be leaf CBs respectively labeled 15 and 19 in FIGS. 7 and 8. The remaining, non-leaf CB may be partitioned into three CBs based on another horizontal ternary tree partition. The resulting three CBs may all be leaf CBs respectively labeled 16, 17, and 18 in FIGS. 7 and 8.

Altogether, CTB 700 may be partitioned into 20 leaf CBs respectively labeled 0-19. The 20 leaf CBs may correspond to 20 leaf nodes (e.g., 20 leaf nodes of tree 800 shown in FIG. 8). The resulting combination of quadtree and multi-type tree partitioning of the CTB 700 may be scanned using a z-scan (left-to-right, top-to-bottom) to form the sequence order for encoding/decoding the CB leaf nodes. A numeric label of each CB leaf node in FIGS. 7 and 8 may correspond to the sequence order for encoding/decoding, with CB leaf node 0 encoded/decoded first and CB leaf node 19 encoded/decoded last. Although not shown in FIGS. 7 and 8, it should be noted that each CB leaf node may comprise one or more PBs and/or TBs.

A coding standard/format (e.g., HEVC, VVC, or any other coding standard/format) may define various units (e.g., in addition to specifying various blocks (e.g., CTBs, CBs, PBs, TBs)). Blocks may comprise a rectangular area of samples in a sample array. Units may comprise the collocated blocks of samples from the different sample arrays (e.g., luma and chroma sample arrays) that form a picture as well as syntax elements and prediction data of the blocks. A coding tree unit (CTU) may comprise the collocated CTBs of the different sample arrays and may form a complete entity in an encoded bitstream. A coding unit (CU) may comprise the collocated CBs of the different sample arrays and syntax structures used to code the samples of the CBs. A prediction unit (PU) may comprise the collocated PBs of the different sample arrays and syntax elements used to predict the PBs. A transform unit (TU) may comprise TBs of the different samples arrays and syntax elements used to transform the TBs.

A block may refer to any of a CTB, CB, PB, TB, CTU, CU, PU, and/or TU (e.g., in the context of HEVC, VVC, or any other coding format/standard). A block may be used to refer to similar data structures in the context of any video coding format/standard/protocol. For example, a block may refer to a macroblock in the AVC standard, a macroblock or a sub-block in the VP8 coding format, a superblock or a sub-block in the VP9 coding format, and/or a superblock or a sub-block in the AV1 coding format.

In intra prediction, samples of a block to be encoded (e.g., also referred to as a current block) may be predicted from samples in a line of samples immediately adjacent to the current block. For example, the line of samples may include samples of the column immediately adjacent to the left-most column of the current block and samples of the row immediately adjacent to the top-most row of the current block. The samples from the immediately adjacent column and row may be jointly referred to as reference samples. Each sample of the current block may be predicted (e.g., in an intra prediction mode) by projecting the position of the sample in the current block in a given direction to a point along the reference samples. The sample may be predicted by interpolating between the two closest reference samples of the projection point if the projection does not fall directly on a reference sample. A prediction error (e.g., referred to as a residual) may be determined for the current block based on differences between the predicted sample values and the original sample values of the current block.

Predicting samples and determining a prediction error based on a difference between the predicted samples and original samples may be performed (e.g., at an encoder) for a plurality of different intra prediction modes (e.g., including non-directional intra prediction modes). The encoder may select one of the plurality of intra prediction modes and its corresponding prediction error to encode the current block. The encoder may send an indication of the selected prediction mode and its corresponding prediction error to a decoder for decoding of the current block. The decoder may decode the current block by predicting the samples of the current block, using the intra prediction mode indicated by the encoder, and/or combining the predicted samples with the prediction error.

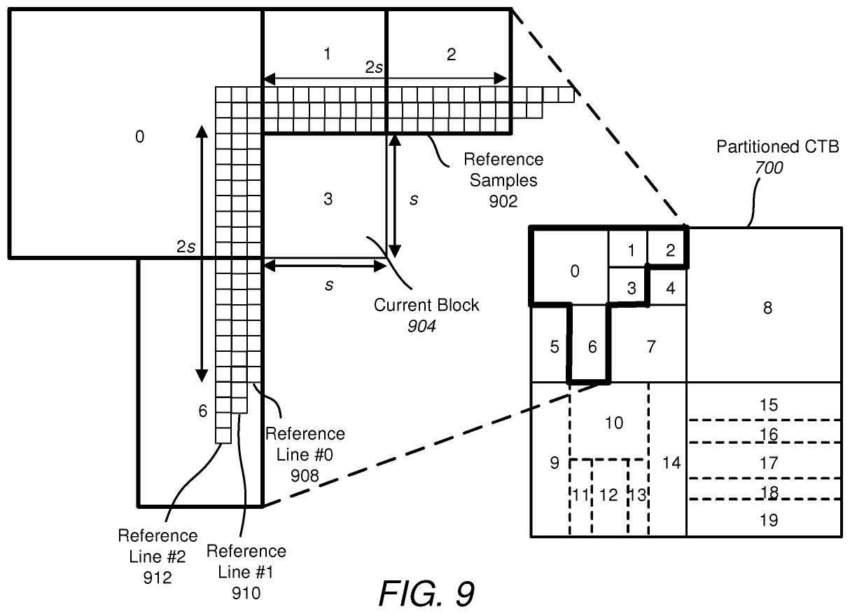

FIG. 9 shows an example set of reference samples 902 determined for intra prediction of a current block 904. Current block 904 may correspond to a block being encoded and/or decoded. Current block 904 may correspond to block 3 of partitioned CTB 700 as shown in FIG. 7. As described herein, the numeric labels 0-19 of the blocks of partitioned CTB 700 may correspond to the sequence order for encoding/decoding the blocks and may be used as such in the example of FIG. 9.

In some embodiments, reference samples 902 may include a line of samples (e.g., reference line #0 908) immediately adjacent to current block 904 and include samples from a column and a row immediately adjacent to current block 904. For example, the line of samples may include reference samples to the left and/or above current block 904. In some embodiments, reference samples 902 may be obtained (or selected) from a reference line of multiple reference lines (MRL), which may include samples adjacent to current block 904 and also non-adjacent samples. The MRL may include reference lines (e.g., reference lines 908-912) identified by corresponding reference line indices (e.g., also referred to as reference line numbers and may be identified by a variable/parameter rl_num) that indicate an i-th line of samples (e.g., i being rl_num+1) adjacent to current block 904 such that an rl_num of 0 indicates the reference line immediately adjacent (or closest) to current block 904 (i.e., a 1^{st} line of samples) and a higher value of rl_num indicates a line of samples further away from current block 904. In other words, the reference line index (which may be equivalently referred to as reference line number) may indicate a specific reference line with a unique abscissa and/or ordinate with respect to current block 904 (e.g., from a top left sample of current block 904). For example, reference samples 902 for predicting current block 904 may be retrieved or determined from reference line #0 908 (i.e., rl_num=0), reference line #1 910 (i.e., rl_num=1), or reference line #2 912 (i.e., rl_num=2). An encoder may select a reference line from a set of MRL (for example, including reference lines 908-912) and signal an MRL index (MRL_INDEX) in the bitstream to indicate the selected reference line. For example, the encoder may signal a codeword encoding the MRL index. The decoder may decode the codeword to determine the MRL index that identifies a specific reference line used in intra prediction of current block 904.

The set of MRL may be from an MRL list storing reference line indices (e.g., rl_num) indicating/identifying the corresponding reference lines. In some examples, the MRL list may include non-adjacent reference lines such as reference lines 1, 3, 5, 7, and/or 12. In this example, the MRL list may be an ordered list of reference line indices such as {0, 1, 3, 5, 7, 12}, where the index 0 of the MRL list points (i.e., MRL_INDEX=0) to reference line 0 (i.e., rl_num=0), index 1 of the MRL list (i.e., MRL_INDEX=1) points to reference line 1 (i.e., rl_num=1), index 2 of the MRL list (i.e., MRL_INDEX=2) points to reference line 3 (i.e., rl_num=3), index 3 of the MRL list (i.e., MRL_INDEX=3) points to reference line 5 (i.e., rl_num=5), index 4 of the MRL list (i.e., MRL_INDEX=4) points to reference line 7 (i.e., rl_num=7), and index 5 of the MRL list (i.e., MRL_INDEX=5) points to reference line 12 (i.e., rl_num=12).

In some embodiments, the MRL list may be a preconfigured list of reference line indices. For example, the same MRL list may be predetermined and stored at both the encoder and the decoder such that the MRL list does not need to be signaled from the encoder to the decoder. In some embodiments, the MRL list may include a set of reference line indices selected at the encoder and the MRL list may be signaled in the bitstream to the decoder. For example, the MRL list may be signaled per CTU, per picture frame, per sequence of picture frame, or per video, etc.

In some embodiments, the encoder may signal a specific reference line (e.g., indicated by a reference line number/index) by signaling in the bitstream an index of the MRL list (e.g., MRL_INDEX), which may be identically determined at the decoder. The decoder may decode the MRL index to select a reference line index from the MRL list and use the reference line identified by the reference line index for intra prediction of current block 904.

For current block 904 that is w×h samples in size, reference samples 902 may comprise: 2w samples (or any other quantity of samples) of an i-th row (e.g., indicated by an MRL index) adjacent to the top-most row of current block 904, 2 h samples (or any other quantity of samples) of the i-th column adjacent to the left-most column of current block 904, and the top left neighboring corner sample(s) extending from the i-th column and i-th row with respect to current block 904. Current block 904 may be square, such that w=h=s. In other examples, a current block need not be square, such that w h. Available samples from neighboring blocks of current block 904 may be used for constructing the set of reference samples 902. Samples may not be available for constructing the set of reference samples 902, for example, if the samples lie outside the picture of the current block, the samples are part of a different slice of the current block (e.g., if the slices are configured and/or used), and/or the samples belong to blocks that have been inter coded and constrained intra prediction is indicated. In some examples, intra prediction cannot be dependent on inter predicted blocks, for example, if constrained intra prediction is indicated.

Samples that may not be available for constructing the set of reference samples 902 may comprise samples in blocks that have not already been encoded and reconstructed at an encoder and/or decoded at a decoder based on the sequence order for encoding/decoding. Restriction of such samples from inclusion in the set of reference samples 902 may allow identical prediction results to be determined at both the encoder and decoder. In the example of FIG. 9, samples from neighboring blocks 0, 1, 2, and 8 may be available to construct reference samples 902 given that these blocks are encoded and reconstructed at an encoder and decoded at a decoder prior to coding of current block 904. The samples from neighboring blocks 0, 1, 2, and 8 may be available to construct reference samples 902, for example, if there are no other issues (e.g., as mentioned above) preventing the availability of the samples from the neighboring blocks 0, 1, 2, and 8. The portion of reference samples 902 from neighboring block 6 may not be available due to the sequence order for encoding/decoding (e.g., because the block 6 may not have already been encoded and reconstructed at the encoder and/or decoded at the decoder based on the sequence order for encoding/decoding).

In some examples, unavailable samples from reference samples 902 may be filled with one or more of the available reference samples 902. For example, an unavailable reference sample may be filled with a nearest available reference sample. The nearest available reference sample may be determined by moving in a clock-wise direction through reference samples 902 from the position of the unavailable reference. The reference samples 902 may be filled with the mid-value of the dynamic range of the picture being coded, for example, if no reference samples are available.

In some examples, a filtering scheme (e.g., a filtering algorithm) may be applied to reference samples 902 to improve prediction accuracy. The filtering scheme may be one of a plurality of filter types including at least: a smoothing filter (or reference sample smoothing filter) or an interpolation filter. In some examples, if reference samples of a given block are to be filtered, only one of the plurality of filter types is selected (e.g., activated) to be applied to the reference samples. For example, if the smoothing filter is selected (e.g., activated), the interpolation filter is not selected (e.g., disabled) or vice versa.

In some examples, a first activation flag for reference sample smoothing (and corresponding smoothing filter) may be determined (e.g., derived) based on deriving intra-prediction parameters, and a second activation flag for interpolation filtering may be derived as the opposite (e.g., complementary) of the first activation flag.

In some examples, both the smoothing filter and the interpolation filter may be disabled based on at least one of the following conditions: reference samples filtering being disabled for a sequence of picture frames including a frame of current block 904; current block 904 being coded using Multiple Reference Lines (MRL) or Intra Sub-Partitions (ISP) modes; a size of current block 904 (e.g., w×h samples) being smaller than or equal to a threshold size (e.g., a predetermined threshold such as 32); an intra prediction mode for current block 904 being DC; the minimum of, the absolute difference between current block 904 intra prediction mode and the vertical angle (e.g., angle with index 50), and the absolute difference between current block 904 intra prediction mode and the horizontal angle (e.g., angle with index 18), being lower than a threshold adaptive to the current block 904 size. If none of these conditions are true, reference samples 902 may be filtered using the smoothing filter (e.g., reference sample smoothing) if an intra prediction mode for current block 904 does not use or imply fractional sample positions. In this case, the interpolation filter is disabled for the current intra mode prediction. If the intra prediction mode uses fractional sample positions, the smoothing filter (e.g., reference sample smoothing) is disabled and the interpolation filtering is enabled.

In some examples, if the reference samples smoothing is activated, the unfiltered and filtered reference samples are available for intra prediction and may be stored in respective buffers.

Samples of current block 904 may be intra predicted based on reference samples 902, for example, based on (e.g., after) determination and (optionally) filtering of reference samples 902. Many encoders/decoders may support a plurality of intra prediction modes in accordance with one or more video coding standards. For example, HEVC supports 35 intra prediction modes, including a planar mode, a direct current (DC) mode, and 33 angular modes. VVC supports 67 intra prediction modes, including a planar mode, a DC mode, and 65 angular modes. Planar and DC modes may be used to predict smooth and gradually changing regions of a picture. Angular modes may be used to predict directional structures in regions of a picture. Any quantity of intra prediction modes may be supported.

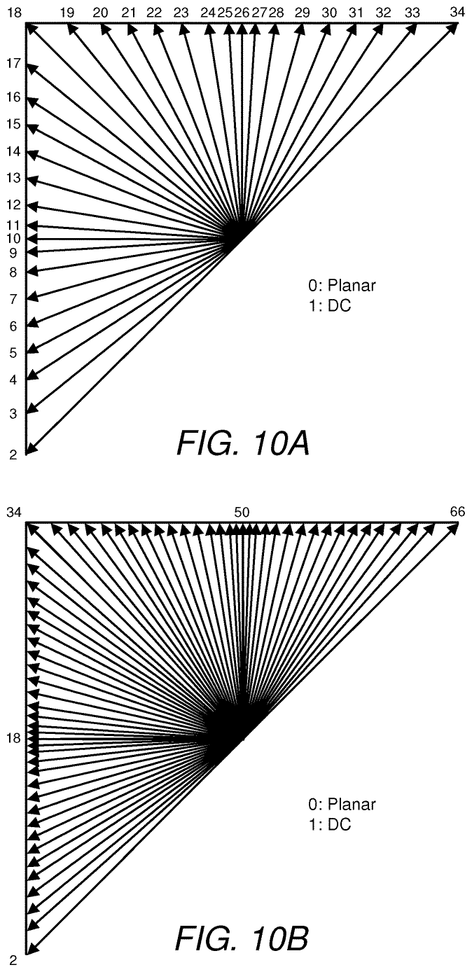

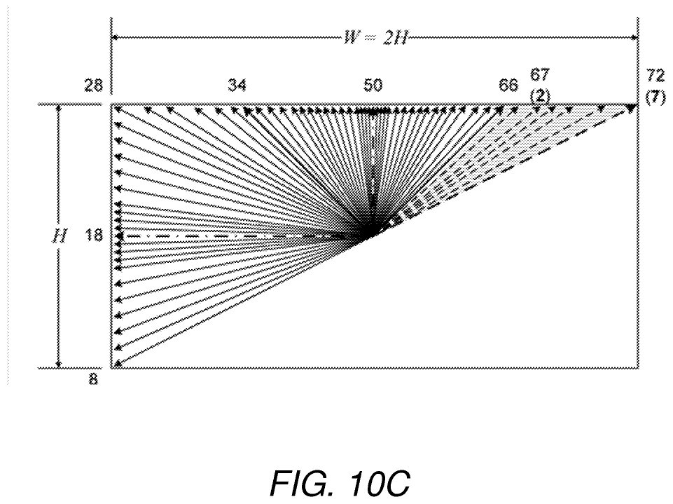

FIGS. 10A-C show example intra prediction modes. FIG. 10A shows 35 intra prediction modes, such as supported by HEVC. The 35 intra prediction modes may be indicated/identified by indices 0 to 34. Prediction mode 0 may correspond to planar mode. Prediction mode 1 may correspond to DC mode. Prediction modes 2-34 may correspond to angular modes. Prediction modes 2-18 may be referred to as horizontal prediction modes because the principal source of prediction is in the horizontal direction. Prediction modes 19-34 may be referred to as vertical prediction modes because the principal source of prediction is in the vertical direction.

FIG. 10B shows 67 intra prediction modes, such as supported by VVC. The 67 intra prediction modes may be indicated/identified by indices 0 to 66. Prediction mode 0 may correspond to planar mode. Prediction mode 1 corresponds to DC mode. Prediction modes 2-66 may correspond to angular modes. Prediction modes 2-34 may be referred to as horizontal prediction modes because the principal source of prediction is in the horizontal direction. Prediction modes 35-66 may be referred to as vertical prediction modes because the principal source of prediction is in the vertical direction. Some of the intra prediction modes illustrated in FIG. 10B may be adaptively replaced by wide-angle directions because blocks in VVC need not be squares.

FIG. 10C shows an example of wide-angle intra prediction (WAIP) modes, such as those supported by VVC. These prediction modes are indicated/identified by indices 67-72 and correspond to angular modes used for predicting blocks of rectangular shapes. The use of WAIP modes enables extending the angles to the block aspect ratio to cover the equal angles as in the case of a square block. These WAIP modes correspond to prediction directions with angles greater than 450 relative to the horizontal or vertical mode.

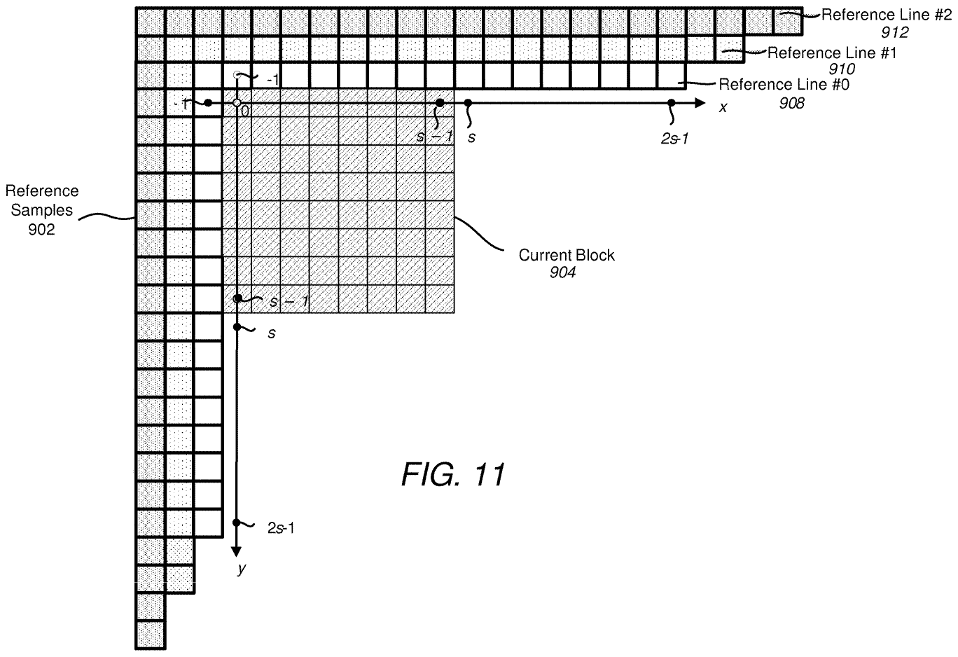

FIG. 11 shows a current block 904 and corresponding reference samples 902 from FIG. 9. To further describe how intra prediction modes are applied to determine a prediction (e.g., a prediction block) of current block 904, FIG. 11 shows current block 904 and reference samples 902, from a reference line among a set of multiple reference lines (MRL) 908-912, in a two-dimensional x, y plane, where a sample may be referenced as p[x][y]. To simplify the prediction process, reference samples 902 may be placed in two, one-dimensional arrays. The reference samples 902 belonging to a reference line l from the set of MRL 908-912, above the current block 904, may be placed in the one-dimensional array ref₁[x]:

ref₁[x]=p[−l+x][−l], (x≥0). (1)

The reference samples 902 belonging to reference line 1, to the left of current block 904, may be placed in the one-dimensional array ref₂ [y]:

ref₂[y]=p[−l][−l+y], (y≥0). (2)

The variable l represents how many lines away the selected reference line is from current block. For example, if reference line #0 908 is selected, then l is set to 1 to indicate the reference line adjacent to current block 904. For example, if reference line #1 910 is selected, then l is set to 2. For example, if reference line #2 912 is selected, then l is set to 3.

In some examples, if MRL is not activated or selected, then reference samples 902 may be from reference line #0 908 that is immediately adjacent to current block 904.

The prediction process may comprise determination of a predicted sample p[x][y](e.g., a predicted value) at a location [x][y] in current block 904. For planar mode, a sample at the location [x][y] in current block 904 may be predicted by determining/calculating the mean of two interpolated values. The first of the two interpolated values may be based on a horizontal linear interpolation at the location [x][y] in current block 904. The second of the two interpolated values may be based on a vertical linear interpolation at location [x][y] in current block 904. The predicted sample p[x][y] in current block 904 may be determined/calculated as:

$$p [ x ] [ y ] = \frac{1}{2 \cdot s} ( h [ x ] [ y ] + v [ x ] [ y ] + s ) , \qquad ( 3 )$$

$$where$$

$$h [ x ] [ y ] = ( s - x - 1 ) \cdot {ref}_{2} [ y ] + ( x + 1 ) \cdot {ref}_{1} [ s ] \qquad ( 4 )$$

may be the horizontal linear interpolation at the location [x][y] in current block 904 and

v[x][y]=(s−y−1)·ref₁[x]+(y+1)·ref₂[s] (5)

may be the vertical linear interpolation at the location [x][y] in current block 904. s may be equal to a length of a side (e.g., a number of samples on a side) of the current block 904.

For DC mode, a sample at a location [x][y] in current block 904 may be predicted by the mean of the reference samples 902. The predicted sample p[x][y] in current block 904 may be determined/calculated as:

$$p [ x ] [ y ] = \frac{1}{2 \cdot s} ( {\sum }_{x = 0}^{s - 1} {ref}_{1} [ x ] + {\sum }_{y = 0}^{s - 1} {ref}_{2} [ y ] ) . \qquad ( 6 )$$

For angular modes, a sample at a location [x][y] in current block 904 may be predicted by projecting the location [x][y] in a direction specified by a given angular mode to a point on the horizontal or vertical line of samples comprising reference samples 902. The sample at the location [x][y] may be predicted by interpolating between the two closest reference samples of the projection point if the projection does not fall directly on a reference sample. The direction specified by the angular mode may be given by an angle φ defined relative to the y-axis for vertical prediction modes (e.g., modes 19-34 in HEVC and modes 35-66 in VVC). The direction specified by the angular mode may be given by an angle φ defined relative to the x-axis for horizontal prediction modes (e.g., modes 2-18 in HEVC and modes 2-34 in VVC).

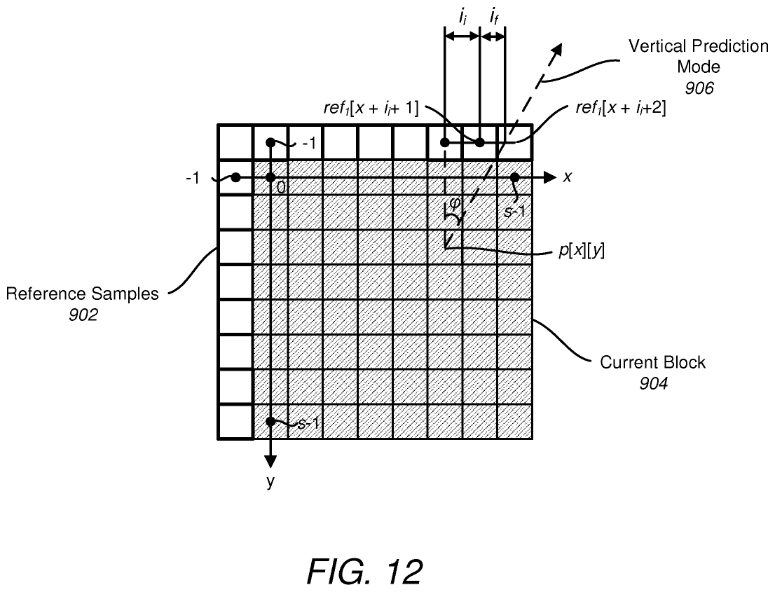

FIG. 12 shows an example of applying an intra prediction mode (e.g., an angular mode such as vertical prediction mode 906) for prediction of a current block 904. FIG. 12 specifically shows prediction of a sample at a location [x][y] in current block 904 for a vertical prediction mode 906. Vertical prediction mode 906 may be given by an angle φ with respect to the vertical axis. The location [x][y] in current block 904, in vertical prediction modes, may be projected to a point (e.g., referred to as a projection point) on the horizontal line of reference samples ref₁[x]. The reference samples 902 are only partially shown in FIG. 12 and shown as being from a reference line with reference line index of 0 for ease of illustration. Reference samples 902 may be from another reference line of the set of MRL, as explained in FIG. 9. As shown in FIG. 12, the projection point on the horizontal line of reference samples ref₁[x] may not be exactly on a reference sample. A predicted sample p[x][y] in current block 904 may be determined/calculated by linearly interpolating between the two reference samples, for example, if the projection point falls at a fractional sample position between two reference samples. The predicted sample p[x][y] may be determined/calculated as:

p[x][y]=(1−i_{f})·ref₁[x+iᵢ+1]+i_{f}·ref₁[x+iᵢ+2]. (7)

iᵢ may be the integer part of the horizontal displacement of the projection point relative to the location [x][y]. iᵢ may be determined/calculated as a function of the tangent of the angle φ of the vertical prediction mode 906 as:

i_{f}=└(y+1)·tan φ┘. (8)

i_{f} may be the fractional part of the horizontal displacement of the projection point relative to the location [x][y] and may be determined/calculated as:

i_{f}=((y+1)·tan φ)−└(y+1)·tan q┘, (9)

where └·┘ is the integer floor function.

For horizontal prediction modes, a location [x][y] of a sample in current block 904 may be projected onto the vertical line of reference samples ref₂[y]. A predicted sample p[x][y] for horizontal prediction modes may be determined/calculated as:

p[x][y]=(1−i_{f})·ref₂[y+iᵢ+1]+i_{f}·ref₂[y+iᵢ+2]. (10)

iᵢ may be the integer part of the vertical displacement of the projection point relative to the location [x][y]. iᵢ may be determined/calculated as a function of the tangent of the angle φ of the horizontal prediction mode as:

i_{f}=└(x+1)·tan φ┘. (11)

i_{f} may be the fractional part of the vertical displacement of the projection point relative to the location [x][y]. i_{f} may be determined/calculated as:

i_{f}=((x+1)·tan φ)−└(x+1)·tan φ┘, (12)

where └·┘ is the integer floor function.

The interpolation functions given by Equations (7) and (10) may be implemented by an encoder and/or a decoder (e.g., encoder 200 in FIG. 2 and/or decoder 300 in FIG. 3). The interpolation functions may be implemented by finite impulse response (FIR) filters. For example, the interpolation functions may be implemented as a set of two-tap FIR filters. The coefficients of the two-tap FIR filters may be respectively given by (1-i_{f}) and i_{f}. The predicted sample p[x][y], in angular intra prediction, may be calculated with some predefined level of sample accuracy (e.g., 1/32 sample accuracy, or accuracy defined by any other metric). For 1/32 sample accuracy, the set of two-tap FIR interpolation filters may comprise up to 32 different two-tap FIR interpolation filters—one for each of the 32 possible values of the fractional part of the projected displacement i_{f}. In other examples, different levels of sample accuracy may be used.

In some examples, the FIR filters may be used for predicting chroma samples and/or luma samples. For example, the two-tap interpolation FIR filter may be used for predicting chroma samples and a same and/or a different interpolation technique/filter may be used for luma samples. For example, a four-tap FIR filter may be used to determine a predicted value of a luma sample. Coefficients of the four-tap FIR filter may be determined based on i_{f} (e.g., similar to the two-tap FIR filter). For 1/32 sample accuracy, a set of 32 different four-tap FIR filters may comprise up to 32 different four-tap FIR filters—one for each of the 32 possible values of the fractional part of the projected displacement i_{f}. In other examples, different levels of sample accuracy may be used. The set of four-tap FIR filters may be stored in a look-up table (LUT) and referenced based on i_{f}. A predicted sample p[x][y], for vertical prediction modes, may be determined based on the four-tap FIR filter as:

$$p [ x ] [ y ] = {\sum }_{i = 0}^{3} fT [ i ] \cdot {ref}_{1} [ x + iIdx + i ] , \qquad ( 13 )$$

where fI[i], i=0 . . . 3, may be the filter coefficients, and Idx is integer displacement. A predicted sample p[x][y], for horizontal prediction modes, may be determined based on the four-tap FIR filter as:

$$p [ x ] [ y ] = {\sum }_{i = 0}^{3} fT [ i ] \cdot {ref}_{2} [ y + iIdx + i ] . \qquad ( 14 )$$

Supplementary reference samples may be determined/constructed if the location [x][y] of a sample in current block 904 to be predicted is projected to a negative x coordinate. The location [x][y] of a sample may be projected to a negative x coordinate, for example, if negative vertical prediction angles φ are used. The supplementary reference samples may be determined/constructed by projecting the reference samples in ref₂[y] in the vertical line of reference samples 902 to the horizontal line of reference samples 902 using the negative vertical prediction angle φ. Supplementary reference samples may be similarly determined/constructed, for example, if the location [x][y] of a sample in current block 904 to be predicted is projected to a negative y coordinate. The location [x][y] of a sample may be projected to a negative y coordinate, for example, if negative horizontal prediction angles φ are used. The supplementary reference samples may be determined/constructed by projecting the reference samples in ref₁[x] on the horizontal line of reference samples 902 to the vertical line of reference samples 902 using the negative horizontal prediction angle φ.

An encoder may determine/predict samples of a current block being encoded (e.g., current block 904) for a plurality of intra prediction modes (e.g., using one or more of the functions described herein). For example, an encoder may determine/predict samples of a current block for each of 35 intra prediction modes in HEVC and/or 67 intra prediction modes in VVC. The encoder may determine, for each intra prediction mode applied, a corresponding prediction error for the current block based on a difference (e.g., sum of squared differences (SSD), sum of absolute differences (SAD), or sum of absolute transformed differences (SATD)) between the prediction samples, generated from reference samples 902 of a reference line (e.g., from a set of MRL), determined for the intra prediction mode and the original samples of the current block. The encoder may determine/select one of the intra prediction modes to encode the current block based on the determined prediction errors. For example, the encoder may determine/select one of the intra prediction modes that results in the smallest prediction error for the current block. In some examples, the encoder may determine/select the intra prediction mode and the associated reference line to encode the current block based on a rate-distortion measure (e.g., Lagrangian rate-distortion cost) determined using the prediction errors. The encoder may signal, in the bitstream to a decoder for decoding of the current block, an indication of the determined/selected intra prediction mode and an indication of the associated MRL index (which may indicate a reference line index). The encoder may also signal in the bitstream to the decoder a corresponding prediction error (e.g., residual) of the intra prediction mode.

A decoder may determine/predict samples of a current block being decoded (e.g., current block 904) for an intra prediction mode. For example, a decoder may receive an indication of a reference line (e.g., a reference line index or an MRL index associated with the reference line index) and an intra prediction mode (e.g., an angular intra prediction mode) from an encoder for a current block. The decoder may retrieve a set of reference samples and perform intra prediction based on the MRL index and the intra prediction mode indicated by the encoder for the current block in a similar manner (e.g., as described above for the encoder). For example, the decoder may obtain the reference samples from a reference line indicated/identified by the decoded MRL index. In some examples, when MRL is not enabled/activated/selected, the reference line has reference line index 0 and is immediately adjacent to the current block. In these examples, no indication of MRL index is signaled.

The decoder may add predicted values of the samples (e.g., determined based on the intra prediction mode) of the current block to a residual of the current block to reconstruct the current block. In some examples, a decoder need not receive an indication of an angular intra prediction mode from an encoder for a current block. Instead, the decoder may determine an intra prediction mode through other decoder-side means (e.g., by applying template-based intra mode derivation (TIMD) tool/technique).

While various examples herein correspond to intra prediction modes in HEVC and VVC, the methods, devices, and systems as described herein may be applied to/used for other intra prediction modes (e.g., as used in other video coding standards/formats, such as VP8, VP9, AV1, etc.).

Intra prediction may exploit correlations between spatially neighboring samples in the same picture of a video sequence to perform video compression. Inter prediction is another coding tool that may be used to perform video compression. Inter prediction may exploit correlations in the time domain between blocks of samples in different pictures of a video sequence. For example, an object may be seen across multiple pictures of a video sequence. The object may move (e.g., by some translation and/or affine motion) or remain stationary across the multiple pictures. A current block of samples in a current picture being encoded may have/be associated with a corresponding block of samples in a previously decoded picture. The corresponding block of samples may accurately predict the current block of samples. The corresponding block of samples may be displaced from the current block of samples, for example, due to movement of the object, represented in both blocks, across the respective pictures of the blocks. The previously decoded picture may be a reference picture. The corresponding block of samples in the reference picture may be a reference block for motion compensated prediction. An encoder may use a block matching technique to estimate the displacement (or motion) of the object and/or to determine the reference block in the reference picture.

Similar to intra prediction, an encoder may determine a difference between a current block and a prediction for a current block. An encoder may determine a difference, for example, based on/after determining/generating a prediction for a current block (e.g., using inter prediction). The difference may be a prediction error (e.g., a residual). The encoder may store and/or send (e.g., signal), in/via a bitstream, the prediction error and/or other related prediction information. The prediction error and/or other related prediction information may be used for decoding and/or other forms of consumption. A decoder may decode the current block by predicting the samples of the current block (e.g., by using the related prediction information) and combining the predicted samples with the prediction error.

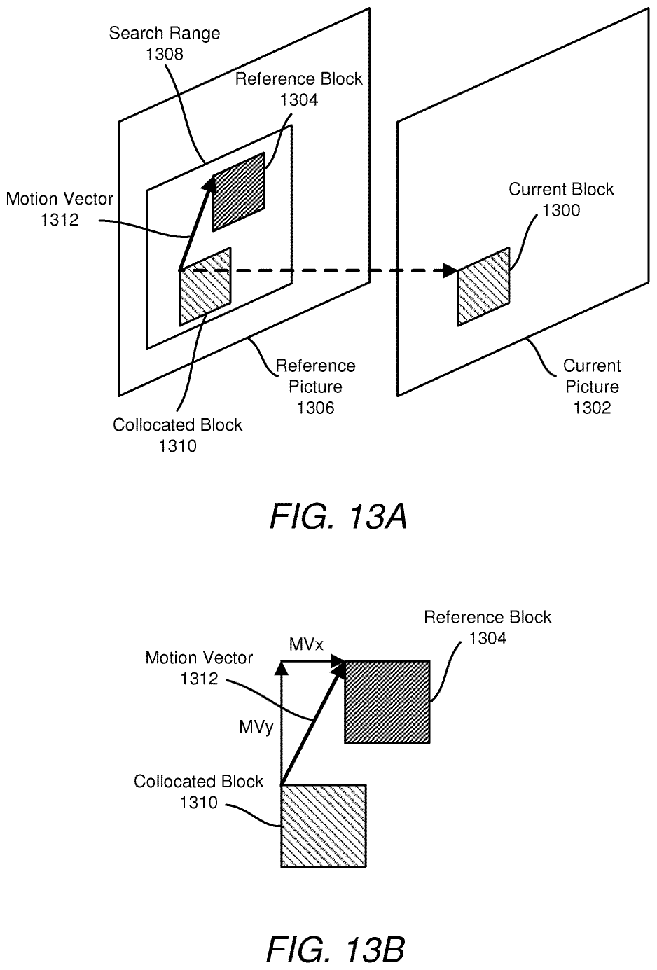

FIG. 13A shows an example of inter prediction. The inter prediction may be performed for a current block 1300 in a current picture 1302 being encoded. An encoder (e.g., encoder 200 as shown in FIG. 2) may perform inter prediction to determine and/or generate a reference block 1304 in a reference picture 1306. Reference block 1304 may be used to predict the current block 1300. Reference pictures (e.g., reference picture 1306) may be prior decoded pictures available at the encoder and/or a decoder. Availability of a prior decoded picture may depend/be based on whether the prior decoded picture is available in a decoded picture buffer, at the time, current block 1300 is being encoded and/or decoded. The encoder may search the one or more reference pictures 1306 for a block (e.g., a candidate reference block) that is similar (or substantially similar) to current block 1300. The encoder may determine the best matching block from the blocks (e.g., candidate reference blocks) tested during the searching process. The best matching block may be a reference block 1304. The encoder may determine that reference block 1304 is the best matching reference block based on one or more cost criteria. The one or more cost criteria may comprise a rate-distortion criterion (e.g., Lagrangian rate-distortion cost). The one or more cost criteria may be based on a difference (e.g., SSD, SAD, and/or SATD) between prediction samples of reference block 1304 and original samples of current block 1300.

The encoder may search for reference block 1304 within a reference region (e.g., a search range 1308). The reference region (e.g., a search range 1308) may be positioned around a collocated block (or position) 1310, of current block 1300, in reference picture 1306. Collocated block 1310 may have a same position in the reference picture 1306 as the current block 1300 in the current picture 1302. The reference region (e.g., search range 1308) may at least partially extend outside of reference picture 1306. Constant boundary extension may be used, for example, if the reference region (e.g., search range 1308) extends outside of reference picture 1306. The constant boundary extension may be used such that values of the samples in a row or a column of reference picture 1306, immediately adjacent to a portion of the reference region (e.g., search range 1308) extending outside of reference picture 1306, may be used for sample locations outside of reference picture 1306. A subset of potential positions, or all potential positions, within the reference region (e.g., search range 1308) may be searched for reference block 1304. The encoder may utilize one or more search implementations to determine and/or generate the reference block 1304. For example, the encoder may determine a set of candidate search positions based on motion information of neighboring blocks (e.g., a motion vector 1312) to the current block 1300.

One or more reference pictures may be searched by the encoder during inter prediction to determine and/or generate the best matching reference block. The reference pictures searched by the encoder may be included in (e.g., added to) one or more reference picture lists. For example, in HEVC and VVC (and/or in one or more other communication protocols), two reference picture lists may be used (e.g., a reference picture list 0 and a reference picture list 1). A reference picture list may include one or more pictures. The reference picture 1306 of reference block 1304 may be indicated by a reference index pointing into a reference picture list comprising reference picture 1306.

FIG. 13B shows an example motion vector. A displacement between reference block 1304 and current block 1300 may be interpreted as an estimate of the motion between reference block 1304 and current block 1300 across their respective pictures. The displacement may be represented by a motion vector 1312. For example, motion vector 1312 may be indicated by a horizontal component (MVx) and a vertical component (MVy) relative to the position of current block 1300. A motion vector (e.g., motion vector 1312) may have fractional or integer resolution. A motion vector with fractional resolution may point between two samples in a reference picture to provide a better estimation of the motion of current block 1300. For example, a motion vector may have ½, ¼, ⅛, 1/16, 1/32, or any other fractional sample resolution. Interpolation between the two samples at integer positions may be used to generate a reference block and its corresponding samples at fractional positions, for example, if a motion vector points to a non-integer sample value in the reference picture. The interpolation may be performed by a filter with two or more taps.

The encoder may determine a difference (e.g., a corresponding sample-by-sample difference) between reference block 1304 and current block 1300. The encoder may determine the difference between reference block 1304 and current block 1300, for example, based on/after reference block 1304 is determined and/or generated, using inter prediction, for current block 1300. The difference may be a prediction error (e.g., a residual). The encoder may store and/or send (e.g., signal), in/via a bitstream, the prediction error and/or related motion information. The prediction error and/or the related motion information may be used for decoding (e.g., decoding current block 1300) and/or other forms of consumption. The motion information may comprise the motion vector 1312 and a reference indicator/index. The reference indicator may indicate the reference picture 1306 in a reference picture list. In other examples, the motion information may comprise an indication of motion vector 1312 and/or an indication of the reference indicator/index. The reference indicator may indicate reference picture 1306 in the reference picture list comprising reference picture 1306. A decoder may decode current block 1300 by determining and/or generating the reference block 1304, which may correspond to/form (e.g., be considered as) a prediction of the current block 1300. The decoder may determine and/or generate the reference block 1304, for example, based on the related motion information. The decoder may decode current block 1300 based on combining the prediction (e.g., a reference block) with the prediction error (e.g., a residual block).

Inter prediction, as shown in FIG. 13A, may be performed using one reference picture 1306 as a source of a prediction for current block 1300. Inter prediction based on a prediction of a current block using a single picture may be referred to as uni-prediction.

Inter prediction of a current block, using bi-prediction, may be based on two pictures (e.g., the source of prediction may be from the two pictures). Bi-prediction may be useful, for example, if a video sequence comprises fast motion, camera panning, zooming, and/or scene changes. Bi-prediction also may be useful to capture fade outs of one scene or fade outs from one scene to another, where two pictures may effectively be displayed simultaneously with different levels of intensity.

One or both of uni-prediction and bi-prediction may be available/used for performing inter prediction (e.g., at an encoder and/or at a decoder). Performing a specific type of inter prediction (e.g., uni-prediction and/or bi-prediction) may depend on a slice type of current block. For example, for P slices, only uni-prediction may be available/used for performing inter prediction. For B slices, either uni-prediction or bi-prediction may be available/used for performing inter prediction. An encoder may determine and/or generate a reference block, for predicting a current block, from a reference picture list 0, for example, if the encoder is using uni-prediction. An encoder may determine and/or generate a first reference block, for predicting a current block, from a reference picture list 0 and determine and/or generate a second reference block, for predicting the current block, from a reference picture list 1, for example, if the encoder is using bi-prediction.

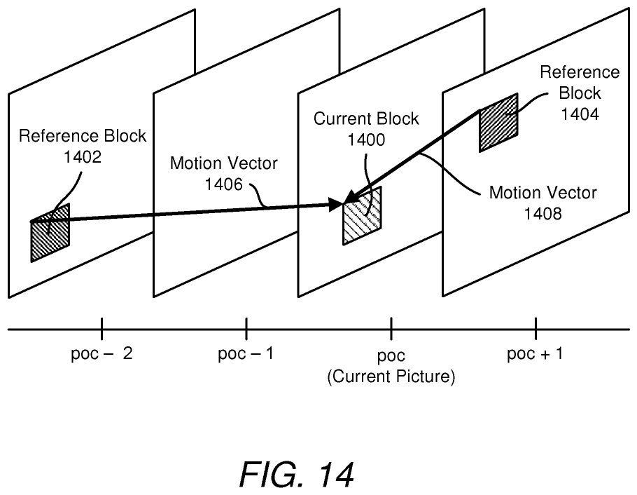

FIG. 14 shows an example of bi-prediction. Two reference blocks 1402 and 1404 may be used to predict a current block 1400. Reference block 1402 may be in a reference picture of one of reference picture list 0 or reference picture list 1. Reference block 1404 may be in a reference picture of another one of reference picture list 0 or reference picture list 1. As shown in FIG. 14, reference block 1402 may be in a first picture that precedes (e.g., in time) a current picture of current block 1400, and the reference block 1404 may be in a second picture that succeeds (e.g., in time) the current picture of current block 1400. The first picture may precede the current picture in terms of a picture order count (POC). The second picture may succeed the current picture in terms of the POC. In other examples, the reference pictures may both precede or both succeed the current picture in terms of POC. A POC may be/indicate an order in which pictures are output (e.g., from a decoded picture buffer). A POC may be/indicate an order in which pictures are generally intended to be displayed. Pictures that are output may not necessarily be displayed but may undergo different processing and/or consumption (e.g., transcoding). The two reference blocks determined and/or generated using/for bi-prediction may correspond to (e.g., be comprised in) a same reference picture. The reference picture may be included in both the reference picture list 0 and the reference picture list 1, for example, if the two reference blocks correspond to the same reference picture.

A configurable weight and/or offset value may be applied to one or more inter prediction reference blocks. An encoder may enable the use of weighted prediction using a flag in a picture parameter set (PPS). The encoder may send/signal the weight and/or offset parameters in a slice segment header for current block 1400. Different weight and/or offset parameters may be sent/signaled for luma and/or chroma components.

The encoder may determine and/or generate the reference blocks 1402 and 1404 for the current block 1400 using inter prediction. The encoder may determine a difference between current block 1400 and each of reference blocks 1402 and 1404. The differences may be prediction errors or residuals. The encoder may store and/or send/signal, in/via a bitstream, the prediction errors and/or their respective related motion information. The prediction errors and their respective related motion information may be used for decoding and/or other forms of consumption.

The motion information for reference block 1402 may comprise a motion vector 1406 and/or a reference indicator/index. The reference indicator may indicate a reference picture, of the reference block 1402, in a reference picture list. In some examples, the motion information for reference block 1402 may comprise an indication of motion vector 1406 and/or an indication of the reference index. The reference index may indicate the reference picture, of reference block 1402, in the reference picture list.

The motion information for reference block 1404 may comprise a motion vector 1408 and/or a reference index/indicator. The reference indicator may indicate a reference picture, of the reference block 1404, in a reference picture list. The motion information for reference block 1404 may comprise an indication of motion vector 1408 and/or an indication of the reference index. The reference index may indicate the reference picture, of the reference block 1404, in the reference picture list.

A decoder may decode current block 1400 by determining and/or generating the reference blocks 1402 and 1404. The decoder may determine and/or generate the reference blocks 1402 and 1404, for example, based on the respective related motion information for the reference blocks 1402 and 1404. The reference blocks 1402 and 1404 may correspond to/form (e.g., be considered as) the prediction (e.g., used to generate a prediction block) of the current block 1400. The decoder may decode the current block 1400 based on combining the prediction with the prediction errors.

Motion information may be predictively coded, for example, before being stored and/or sent/signaled in/via a bit stream (e.g., in HEVC, VVC, and/or other video coding standards/formats/protocols). The motion information for a current block may be predictively coded based on motion information of one or more blocks neighboring the current block. The motion information of the neighboring block(s) may often correlate with the motion information of the current block because the motion of an object represented in the current block is often the same as (or similar to) the motion of objects in the neighboring block(s). Motion information prediction techniques (such as those in HEVC and VVC) may comprise advanced motion vector prediction (AMVP) and/or inter prediction block merging (e.g., merge mode).

An encoder (e.g., encoder 200 as shown in FIG. 2), may code a motion vector. The encoder may code the motion vector (e.g., using AMVP) as a difference between a motion vector of a current block being coded and a motion vector predictor (MVP). An encoder may determine/select the MVP from a list of candidate MVPs. The candidate MVPs may be/correspond to previously decoded motion vectors of neighboring blocks in the current picture of the current block, and/or blocks at or near the collocated position of the current block in other reference pictures. The encoder and/or a decoder may reciprocally generate and/or determine the list of candidate MVPs.

The encoder may determine/select an MVP from the list of candidate MVPs. Then, the encoder may send/signal, in/via a bitstream, an indication of the selected MVP and/or a motion vector difference (MVD). The encoder may indicate the selected MVP in the bitstream using an index/indicator. The index may indicate the selected MVP in the list of candidate MVPs. The MVD may be determined/calculated based on a difference between the motion vector of the current block and the selected MVP. For example, for a motion vector (e.g., comprising a horizontal component (MVx) and a vertical component (MVy)) that indicates a position relative to a position of the current block being coded, the MVD may be represented by two components MVDₓ and MVD_{y}. MVDₓ and MVD_{y} may be determined/calculated as:

MVDₓ=MVₓ−MVPₓ, (15)

MVD_{y}=MV_{y}—MVP_{y}. (16)

MVDx and MVDy may respectively represent horizontal and vertical components of the MVD. MVPx and MVPy may respectively represent horizontal and vertical components of the MVP.

A decoder (e.g., decoder 300 as shown in FIG. 3) may decode the motion vector by adding the MVD to the MVP indicated in/via the bitstream. The decoder may decode the current block by determining and/or generating the reference block. The decoder may determine and/or generate the reference block, for example, based on the decoded motion vector. The reference block may correspond to/form (e.g., be considered as) the prediction of the current block (e.g., a prediction block). The decoder may decode the current block by combining the prediction with the prediction error.

The list of candidate MVPs (e.g., in HEVC, VVC, and/or one or more other communication protocols), for AMVP, may comprise two or more candidates (e.g., candidates A and B). Candidates A and B may comprise: up to two (or any other quantity of) spatial candidate MVPs determined/derived from five (or any other quantity of) spatial neighboring blocks of a current block being coded; one (or any other quantity of) temporal candidate MVP determined/derived from two (or any other quantity of) temporal, co-located blocks (e.g., if both of the two spatial candidate MVPs are not available or are identical); and/or zero motion vector candidate MVPs (e.g., if one or both of the spatial candidate MVPs or temporal candidate MVPs are not available). Other quantities of spatial candidate MVPs, spatial neighboring blocks, temporal candidate MVPs, and/or temporal, co-located blocks may be used for the list of candidate MVPs.

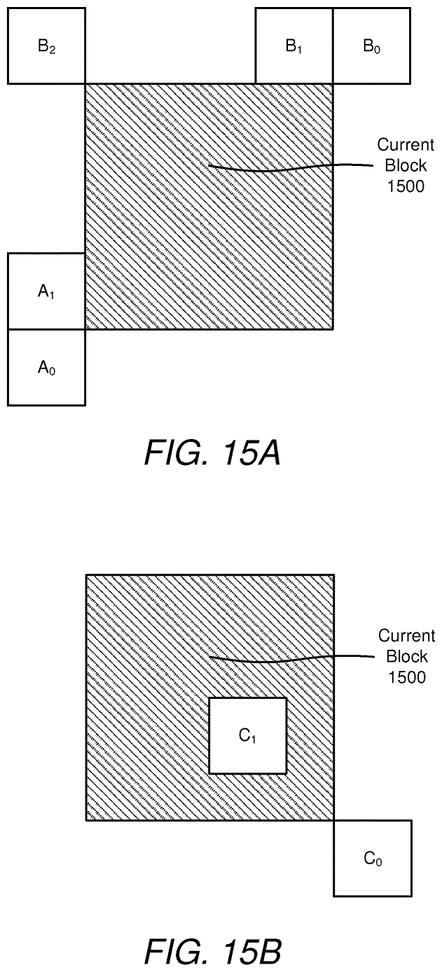

FIG. 15A shows example spatial candidate neighboring blocks for a current block. For example, five (or any other quantity of) spatial candidate neighboring blocks may be located relative to a current block 1500 being encoded. The five spatial candidate neighboring blocks may be A0, A1, B0, B1, and B2. FIG. 15B shows temporal, co-located blocks for the current block. For example, two (or any other quantity of) temporal, co-located blocks may be located relative to current block 1500 being coded. The two temporal, co-located blocks may be C0 and C1. The two temporal, co-located blocks may be in one or more reference pictures that may be different from the current picture of current block 1500.

An encoder (e.g., encoder 200 as shown in FIG. 2) may code a motion vector using inter prediction block merging (e.g., a merge mode). For example, the encoder (e.g., using merge mode) may reuse the same motion information of a neighboring block (e.g., one of neighboring blocks A0, A1, B0, B1, and B2) for inter prediction of a current block. For example, the encoder (e.g., using merge mode) may reuse the same motion information of a temporal, co-located block (e.g., one of temporal, co-located blocks C0 and C1) for inter prediction of a current block. An MVD need not be sent (e.g., indicated, signaled) for the current block because the same motion information as that of a neighboring block or a temporal, co-located block may be used for the current block (e.g., at the encoder and/or a decoder). A signaling overhead for sending/signaling the motion information of the current block may be reduced because the MVD need not be indicated for the current block. The encoder and/or the decoder may reciprocally generate a candidate list of motion information from neighboring blocks or temporal, co-located blocks of the current block (e.g., in a manner similar to AMVP). The encoder may determine to use (e.g., inherit) motion information, of one neighboring block or one temporal, co-located block in the candidate list, for predicting motion information of the current block being coded. The encoder may signal/send, in/via a bitstream, an indication of the determined motion information from the candidate list. For example, the encoder may signal/send an indicator/index. The index may indicate the determined motion information in the list of candidate motion information. The encoder may signal/send the index to indicate the determined motion information.

A list of candidate motion information for merge mode (e.g., in HEVC, VVC, or any other coding formats/standards/protocols) may comprise: up to four (or any other quantity of) spatial merge candidates derived/determined from five (or any other quantity of) spatial neighboring blocks (e.g., as shown in FIG. 15A); one (or any other quantity of) temporal merge candidate derived from two (or any other quantity of) temporal, co-located blocks (e.g., as shown in FIG. 15B); and/or additional merge candidates comprising bi-predictive candidates and zero motion vector candidates. In some examples, the spatial neighboring blocks and the temporal, co-located blocks used for merge mode may be the same as the spatial neighboring blocks and the temporal, co-located blocks used for AMVP.

Inter prediction may be performed in other ways and variants than those described herein. For example, motion information prediction techniques other than AMVP and merge mode may be used. While various examples herein correspond to inter prediction modes, such as used in HEVC and VVC, the methods, devices, and systems as described herein may be applied to/used for other inter prediction modes (e.g., as used for other video coding standards/formats such as VP8, VP9, AV1, etc.). History-based motion vector prediction (HMVP), combined intra/inter prediction mode (CIIP), and/or merge mode with motion vector difference (MMVD) (e.g., as described in VVC) may be performed/used and are within the scope of the present disclosure.

A block matching operation (or technique) may be applied/used (e.g., in inter prediction) to determine a reference block in a different picture than that of a current block being coded (e.g., encoded and/or decoded). A block matching operation also may be applied/used to determine a reference block in a same picture as that of a current block being coded. The reference block, in a same picture as that of the current block, as determined using block matching may often not accurately predict the current block (e.g., for camera captured videos). Prediction accuracy for screen content videos may not be similarly impacted, for example, if a reference block in the same picture as that of the current block is used for encoding. Screen content videos may comprise, for example, computer generated text, graphics, animation, etc. Screen content videos may comprise (e.g., may often comprise) repeated patterns (e.g., repeated patterns of text and/or graphics) within the same picture. Using a reference block (e.g., as determined using block matching), in a same picture as that of a current block being encoded, may provide efficient compression for screen content videos.

A prediction technique may be used (e.g., in HEVC, VVC, and/or any other coding standards/formats/protocols) to exploit correlation between blocks of samples within a same picture (e.g., of screen content videos). The prediction technique may be intra block copy (IBC) or current picture referencing (CPR). An encoder may apply/use a block matching technique (e.g., similar to inter prediction) to determine a displacement vector (e.g., a block vector (BV)). The BV may indicate a relative position of a reference block (e.g., in accordance with intra block compensated prediction), that best matches the current block, from a position of the current block. For example, the relative position of the reference block may be a relative position of a top-left corner (or any other point/sample) of the reference block. The BV may indicate a relative displacement from the current block to the reference block that best matches the current block. The encoder may determine the best matching reference block from blocks tested during a searching process (e.g., in a manner similar to that used for inter prediction). The encoder may determine that a reference block is the best matching reference block based on one or more cost criteria. The one or more cost criteria may comprise a rate-distortion criterion (e.g., Lagrangian rate-distortion cost). The one or more cost criteria may be based on, for example, one or more differences (e.g., an SSD, an SAD, an SATD, and/or a difference determined based on a hash function) between the prediction samples of the reference block and the original samples of the current block. A reference block may correspond to/comprise prior decoded blocks of samples (e.g., reconstructed samples) of the current picture. The reference block may comprise decoded blocks of samples of the current picture prior to being processed by in-loop filtering operations (e.g., deblocking and/or SAO filtering).

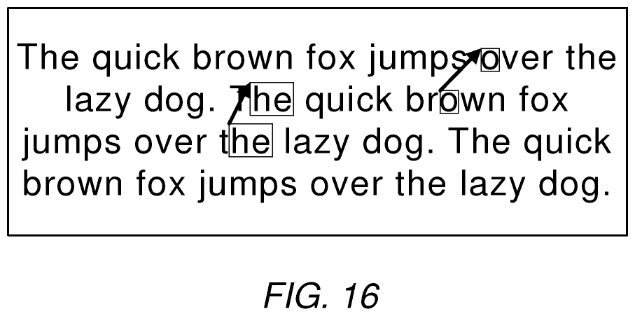

FIG. 16 shows an example of IBC (e.g., an IBC mode). The example shown in FIG. 16 may correspond to screen content. The rectangular portions/sections with arrows beginning at their boundaries may be the current blocks being encoded. The rectangular portions/sections that the arrows point to may be the reference blocks for predicting the respective current blocks.

A reference block may be determined and/or generated, for a current block, using IBC. The encoder may determine a difference (e.g., a corresponding sample-by-sample difference) between the reference block and the current block. The difference may be a prediction error or residual. The encoder may store and/or send/signal, in/via a bitstream the prediction error and/or related prediction information. The prediction error and/or the related prediction information may be used for decoding and/or other forms of consumption. The prediction information may comprise a BV. The prediction information may comprise an indication of the BV. A decoder (e.g., decoder 300 as shown in FIG. 3), may decode the current block by determining and/or generating the reference block. The decoder may determine and/or generate the current block, for example, based on the prediction information (e.g., the BV). The reference block may correspond to/form (e.g., be considered as) the prediction (e.g., a prediction block) of the current block. The decoder may decode the current block by combining the prediction (e.g., prediction block) with the prediction error (e.g., residual or residual block).

A BV may be predictively coded (e.g., in HEVC, VVC, and/or any other coding standards/formats/protocols) before being stored and/or sent/signaled in/via a bitstream. For example, the BV for a current block may be predictively coded based on a BV of one or more blocks neighboring the current block. For example, an encoder may predictively code a BV using the merge mode (e.g., in a manner similar to as described herein for inter prediction), AMVP (e.g., as described herein for inter prediction), or a technique similar to AMVP. The technique similar to AMVP may be BV prediction and difference coding (or AMVP for IBC).

An encoder (e.g., encoder 200 as shown in FIG. 2) performing BV prediction and coding may code a BV as a difference between the BV of a current block being coded and a block vector predictor (BVP). An encoder may select/determine the BVP from a list of candidate BVPs. The candidate BVPs may comprise/correspond to previously decoded BVs of neighboring blocks in the current picture of the current block. The encoder and/or a decoder may reciprocally generate or determine the list of candidate BVPs.

The encoder may send/signal, in/via a bitstream, an indication of the selected BVP and a block vector difference (BVD). The encoder may indicate the selected BVP in the bitstream using an index/indicator. The index may indicate (e.g., point to) the selected BVP in the list of candidate BVPs. The BVD may be determined/calculated based on a difference between a BV of the current block and the selected BVP. For example, for a BV (e.g., represented by a horizontal component (BVx) and a vertical component (BVy)) that indicates a position relative to a position of the current block being coded, the BVD may be represented by two components BVDₓ and BVD_{y}. BVDₓ and BVD_{y} may be determined/calculated as:

BVDₓ=BVₓ−BVPₓ, (17)

BVD_{y}=BV_{y}−BVP_{y}. (18)

BVDx and BVDy may respectively represent horizontal and vertical components of the BVD. BVPx and BVPy may respectively represent horizontal and vertical components of the BVP. A decoder (e.g., decoder 300 as shown in FIG. 3), may decode the BV by adding the BVD to the BVP indicated in/via the bitstream. The decoder may decode the current block by determining and/or generating the reference block. The decoder may determine and/or generate the reference block, for example, based on the decoded BV. The reference block may correspond to/form (e.g., be considered as) the prediction (e.g., a prediction block) of the current block. The decoder may decode the current block by combining the prediction (e.g., the prediction block) with the prediction error (e.g., residual or residual block).

A same BV as that of a neighboring block may be used for the current block and a BVD need not be separately signaled/sent for the current block, such as in the merge mode. A BVP (in the candidate BVPs), which may correspond to a decoded BV of the neighboring block, may itself be used as a BV for the current block. Not sending the BVD may reduce the signaling overhead.

A list of candidate BVPs (e.g., in HEVC, VVC, and/or any other coding standard/format/protocol) may comprise two (or more) candidates. The candidates may comprise candidates A and B. Candidates A and B may comprise: up to two (or any other quantity of) spatial candidate BVPs determined/derived from five (or any other quantity of) spatial neighboring blocks of a current block being encoded; and/or one or more of last two (or any other quantity of) coded BVs (e.g., if spatial neighboring candidates are not available). Spatial neighboring candidates may not be available, for example, if neighboring blocks are encoded using intra prediction or inter prediction. Locations of the spatial candidate neighboring blocks, relative to a current block, being encoded using IBC may be illustrated in a manner similar to spatial candidate neighboring blocks used for coding motion vectors in inter prediction (e.g., as shown in FIG. 15A). For example, five spatial candidate neighboring blocks of a current block being coded using IBC may be respectively denoted A0, A1, B0, B1, and B2 as shown in FIG. 15A.

The most probable mode (MPM) refers to the intra prediction mode (IPM) that is most likely to be the best mode for the current block being encoded or decoded. In current intra prediction techniques, the MPM is determined by analyzing the intra prediction modes of the neighboring CUs (e.g., also referred to as blocks) of a current block (or CU) to be coded (e.g., encoded or decoded). For example, VVC uses a list of 6 MPMs (referred to as the “MPM list”) for luma intra prediction. The MPM list is derived from the intra prediction modes of the neighboring CUs, and is updated as the encoder progresses through the video frame. When encoding a block, the encoder may determine if the current block is a candidate for any of the MPMs in the MPM list. If it is, the encoder then compares the prediction errors of the respective MPMs to determine which MPM from the MPM list is the best mode for the current block. If the current block is not a candidate for any of the MPMs in the MPM list, the encoder may then evaluate all intra prediction modes (e.g., 67 in VVC) to determine the best mode for the current block.

The use of MPMs can significantly improve the coding efficiency because the encoder does not need to signal the intra prediction mode for the current block if it is one of the MPMs. Instead, the decoder can infer the intra prediction mode for the current block from the corresponding MPM list reciprocally and identically generated at the decoder. Thus, signaling overhead in the bitstream may be reduced.

In some examples, three types of intra modes are considered to construct the MPM list: default intra modes; neighboring intra modes; and derived intra modes. A unified 6 MPM list is used for intra blocks irrespective of whether Multiple Reference Lines (MRL) and Intra Sub-Partitions (ISP) coding tools are applied. The MPM list for the current block is constructed based on intra modes of the left neighbor block (e.g., block corresponding to A1 in FIG. 15A) and the above neighbor block (e.g., block corresponding to B1 in FIG. 15A) of the current block. Suppose the mode of the left neighbor block is denoted as Left and the mode of the above neighbor block is denoted as Above, the unified MPM list may be constructed as follows: when a neighboring block is not available, its intra mode is set to planar mode by default; if both modes Left and Above are non-angular modes, then the MPM list is set to include{planar, DC, V, H, V−4, V+4}, where “V” and “H” refer to vertical mode and horizontal mode, respectively; if one of modes Left and Above is an angular mode, and the other is non-angular, set a mode Max as the larger mode in Left and Above, and set MPM list to include {planar, Max, Max−1, Max+1, Max−2, Max+2}; if Left and Above are both angular and they are different, set a mode Max and a mode Min as the larger mode in Left and Above and as the smaller mode in Left and Above, respectively, and thereafter, if Max−Min is equal to 1, then set MPM list to include {planar, Left, Above, Min−1, Max+1, Min−2}, if Max−Min is greater than or equal to 62, then set MPM list to include {planar, Left, Above, Min+1, Max−1, Min+2}, if Max−Min is equal to 2, set MPM list to include {planar, Left, Above, Min+1, Min−1, Max+1}, or otherwise, set MPM list to include {planar, Left, Above, Min−1, Min+1, Max−1}; and if Left and Above are both angular and they are the same, set MPM list to include {planar, Left, Left−1, Left+1, Left−2, Left+2}.

The encoder may encode an MPM index in the bitstream to indicate the position of the selected intra prediction mode in the MPM list to the decoder. The encoder may represent the MPM index as a codeword and entropy encode the codeword into the bitstream. The decoder may derive the MPM list in a manner identical to the encoder, and use the MPM index obtained from the codeword decoded from bitstream to obtain the intra prediction mode from the MPM list derived at the decoder. In some instances, the first bin of codeword, representing the MPM index, is context coded using an arithmetic coder (e.g., CABAC) so as to achieve additional coding efficiencies. For example, three contexts may be used, corresponding to whether the current intra block is MRL enabled, ISP enabled, or a normal intra block.

During the 6 MPM list generation process, pruning may be used to remove duplicated intra modes so that the MPM list includes only unique intra modes. For entropy coding of the 61 non-MPM modes (that is, the 67 modes in VVC minus the 6 MPM), a truncated binary code (TBC) may be used.

In some implementations, the MPM list is extended to include 16 additional candidates, and is divided into two parts, the primary MPM (PMPM) (e.g., including 6 entries) and the secondary MPM (SMPM) (e.g., including 16 entries). In some implementations, the first entry in the general MPM list is the planar mode. The remaining entries include the intra modes of the adjacent neighboring blocks corresponding to positions left (L), above (A), below-left (BL), above-right (AR), and above-left (AL) (e.g., shown in FIG. 15A as A1, B1, A0, B0, and B2), and decoder-side intra mode derivation (DIMD) modes which are sorted in ascending order of a cost such as, for example, SAD, SSD, SATD, etc. In some examples, up to a preconfigured/predetermined number of modes (e.g., 5) with the smallest costs are added to the MPM list. The cost for a respective MPM (e.g., an IPM corresponding to an entry in the MPM list) may be computed between the prediction of the reconstructed samples of the template of the current block and the reconstructed samples. For example, the prediction may be generated by applying the respective MPM for the template. Sorted directional modes are added into the general MPM list, and then the default modes, until the general MPM list with 22 entries is constructed. In some examples, if a CU block is vertically oriented, the order of neighboring blocks corresponds to A, L, BL, AR, AL; otherwise, it is L, A, AL, AR, BL.

Intra template matching prediction (IntraTMP) is a special intra prediction mode that copies a prediction block, from the reconstructed part of the current frame, whose template (e.g., an L-shaped template, above only template, or left-only template) best matches the current template (i.e., the L-shaped template, above only template, or left-only template of the current block). In a predefined search region/range in the reconstructed part of the current frame, the encoder searches for the most similar template to the current template and selects the corresponding block indicated by the selected template as a prediction block (e.g., also referred to as reference block). To perform the matching operation, the current template and the candidate templates that are matched have the same shape and size. In some examples, the matched templates also have the same orientation. The encoder may evaluate the similarity between templates by calculating a matching cost using a cost metric such as SAD, SSD, or SATD. The encoder then signals the usage of this mode, and the same prediction and matching operation is performed at the decoder.

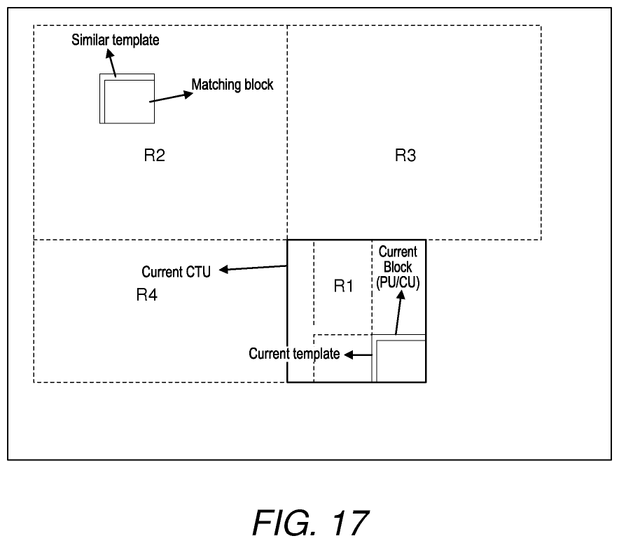

FIG. 17 shows an example of intra template matching search areas for IntraTMP mode, according to some embodiments. In the IntraTMP mode, the prediction for the current block is generated by matching a current template (e.g., the L-shaped, top-only, or left-only causal neighbor) of the current block with a template (e.g., reference template) of another block (e.g., candidate reference block) in a predefined search area, including, for example, a portion of the current CTU (R1), a portion of the top-left CTU (R2), a portion of the above CTU (R3), and a portion of the left CTU (R4).

Within each region R1-R4, the decoder constructs a candidate list of up to a predetermined maximum (e.g., 19) template matching block vectors that are ranked in ascending order according to the respective template cost (e.g., SAD costs). In some examples, a prediction block (e.g., a predictor) of the current block may be generated using one or more of the reference blocks determined using IntraTMP as well as applying one or more optional filters. For example, the following modes may be supported: single predictor, fusion of multiple predictors, sub-pel precision, and linear filter model. In the single predictor mode, a single predictor is selected from the candidate list. In the fusion of multiple predictors mode, multiple predictors are blended to derive the final prediction block. The blending weights are either computed from the template matching cost of each predictor, or with a Wiener-filter based weight derivation method. In the sub-pel precision mode, when a single predictor is used, sub-pel precision can be used with ½-pel precision, ¼-pel precision, or ¾-pel precision, each with 8 possible directions. In the linear filter model mode, a linear filter can be learned (e.g., generated or derived) between the reference template and current template and be applied to the reference block. This mode can be used for the single predictor when sub-pel precision is not used.

In some examples, the dimensions of the regions, specifically the width and height of the search ranges (SearchRange_w, SearchRange_h), may be set proportional to the block dimension (BlkW, BlkH) to have a fixed number of cost comparisons per pixel. For example, SearchRange_w=min (64, a*BlkW); and SearchRange_h=min (64, a*BlkH), where “a” is a constant that controls the gain/complexity trade-off In practice, “a” may be set equal to 5.

To speed-up the template matching process, the search range of all search regions may be subsampled by a factor (e.g., factor of 3). After finding the best match, a refinement process may be performed. The refinement is done via a second template matching search around the best match with a reduced search range associated with the subsampling factor.

In some examples, the IntraTMP mode (or IntraTMP tool) may be enabled for CUs with a size (e.g., width times height) less than or equal to a threshold size (e.g., 64). In an example, the threshold size for largest CU size for IntraTMP is configurable. The IntraTMP prediction mode may be signaled at CU level through a dedicated flag when DIMD is not used for the current CU. Decoder-side Intra Mode Derivation (DIMD) is an intra coding mode in which the intra prediction mode (IPM) is not transmitted in the bitstream (e.g., as in regular intra prediction in which the IPM is signaled after being determined by the encoder using, for example, a rate distortion optimization (RDO) algorithm) but is derived by using a gradient analysis of neighbor reconstructed pixels/samples. By using DIMD, the intra prediction mode is implicitly determined at the decoder. In other words, the intra prediction mode is derived without explicit indication of the intra prediction mode from the encoder to the decoder in the bitstream. DIMD is signaled with a flag and the intra prediction mode is derived during the reconstruction process at the decoder in a manner that is identical to the manner in which the intra prediction mode is derived at the encoder. If DIMD is not selected at the encoder as the intra coding mode for the current block, the intra prediction mode may be parsed from the bitstream at the decoder as in an intra coding mode process that signals the intra prediction mode in the bitstream.

In DIMD, a 3-samples wide (in width or height) template area (composed of left, above, and above-left areas) of the current block is defined in which edge detection filters (e.g., 3×3 horizontal and vertical Sobel filters) adjacent to the current block are applied on all 3×3 window positions centered on the pixels of the middle line of the template area to determine the amplitude and the angle of luminance direction (orientation) for each middle line sample of the template area. It should be understood that other sizes of the template area or size of the edge detection filters may be used. A histogram of gradients (HoG) is computed where each entry (e.g., bin) in the HoG corresponds to a respective conventional intra angular mode. For example, where Ghor and Ger are the intensities of pure horizontal and vertical directions, respectively, as calculated using a Sobel filter at one 3×3 window position, an angle is calculated for the window as angle=arctan(Gₕₒᵣ/Gᵥₑᵣ). The calculated angle may be converted into one of the angular intra prediction modes (e.g., one of the 65 angular intra prediction modes in VVC) represented in the HoG, and the corresponding amplitude (i.e., the amplitude for the window position and also referred to as gradient intensity) amplitude=|Gₕₒᵣ|+|Gᵥₑᵣ| may be added to the HoG indexed by the respective intra prediction modes. Thus, when all window positions in the template area are calculated, each entry in the HoG represents the cumulated amplitude for a respective intra prediction mode.

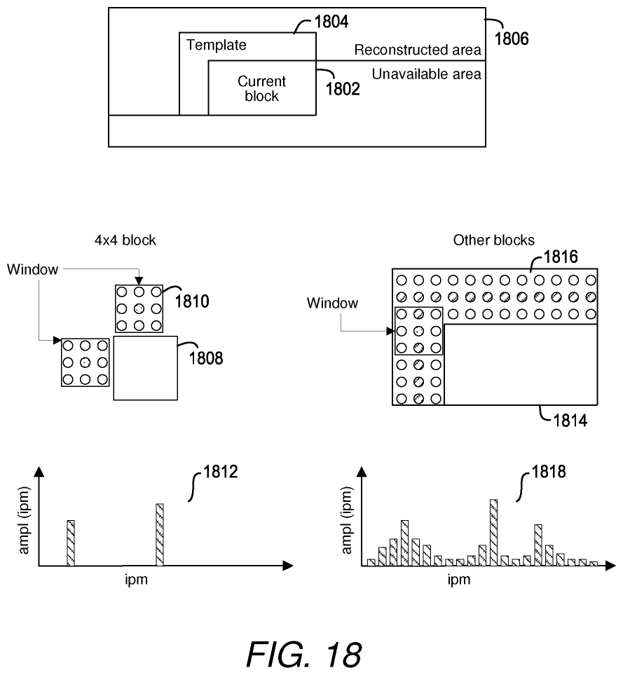

FIG. 18 shows an example DIMD template zone for computing a HoG, according to some embodiments. The reconstructed area 1806 relative to the current block 1802 and a template area 1804 (e.g., an L-shaped template) of the current block 1802 are shown. An example 4×4 pixel square current block 1808 is shown with a 3×3 window 1810 in the template area. The HoG 1812 is the histogram corresponding to current block 1808. Another example rectangular current block 1814 is shown with a 3-pixel deep/wide template area 1816. The HoG 1818 corresponds to the rectangular current block 1814. As illustrated, each coordinate position on the x-axis of the illustrated HoG is a respective intra prediction mode (IPM), and the y-axis represents the cumulative amplitude for the respective intra prediction modes.

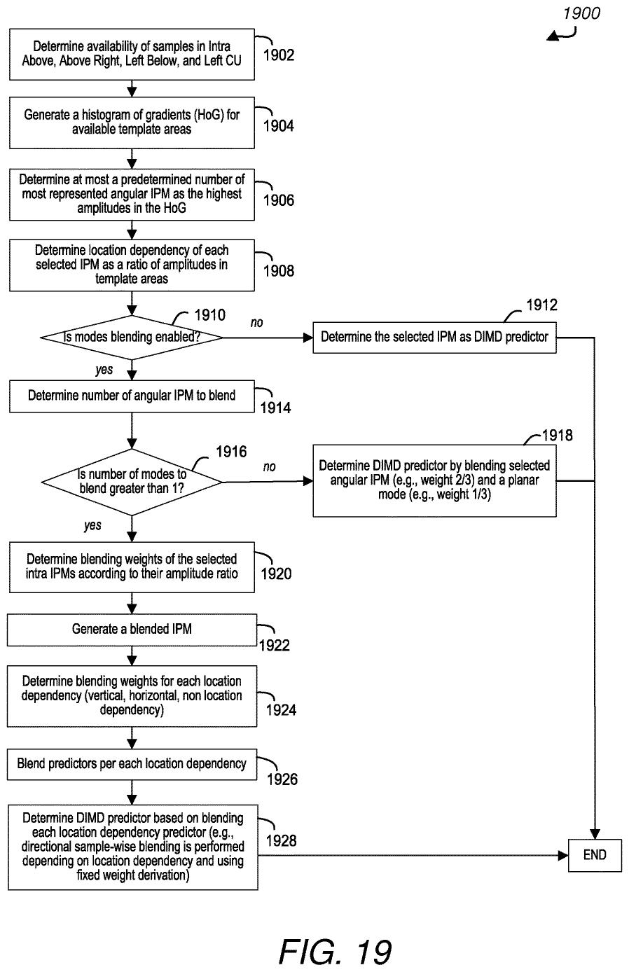

FIG. 19 shows a flowchart 1900 of an example DIMD predictor derivation process, according to some embodiments. The process of flowchart 1900 may be performed identically at the encoder (e.g., encoder 200 of FIG. 2) and the decoder (e.g., decoder 300 of FIG. 3) such that no intra prediction modes need to be explicitly signaled by the encoder to the decoder in the bitstream.

At 1902, the availability of samples in a current template, for example, in the neighboring blocks (e.g., CUs) above, above-right, below-left, and left of a current block to be coded (e.g., encoded and/or decoded) is determined. An example template area 1804 for a current block 1802 is shown in FIG. 18. At 1904, an HoG for available template areas is generated/constructed, e.g., according to the process described with respect to FIG. 18. At 1906, up to a predetermined number (e.g., 5) of the most represented intra prediction modes (IPMs) are identified/determined based on the highest amplitudes in the HoG.

At 1908, the location dependency of each identified IPM is determined as a ratio of amplitudes in template areas (e.g., also referred to as template portions or template regions) of the current template. For example the template areas of the current template may include a left template (e.g., including samples in the current template to the left of the current block), an above template (e.g., including samples in the current template above the current block), and/or an above left template (e.g., including samples in the current template to the left of and above the current block). In some implementations, the location dependency of an identified intra prediction mode can be determined as follows: default location dependency is set to 0 (i.e., no location dependency); if the intra prediction mode's amplitude in the left template (the sum of amplitudes for the identified intra prediction mode from samples in the left template) is less than the intra prediction mode's average amplitude among all templates (e.g., among three template regions—left template, above template, and above left template), then the location dependency is set to 1 (vertical); else if the intra prediction mode's amplitude in the above template is less than the intra prediction mode's average amplitude among all templates, then the location dependency is set to 2 (horizontal). In some implementations, this calculation can be facilitated by, when generating the HoG, cumulating the amplitudes separately for each of the left template region, above template region, and above left template region in respective different HoGs and then subsequently summing the three HoGs to determine the combined HoG for the entire current template.

At 1910, it is determined whether mode blending (e.g., mode fusion) is enabled. If mode blending is disabled, then at 1912 it is determined to use one of the selected IPMs (e.g., corresponding to the highest amplitude) as the DIMD predictor. If it is determined at 1910 that mode blending is enabled, then at 1914, the number of angular IPMs to be blended is determined. Mode blending may be enabled, for example, when the first and second identified IPMs (as the two IPMs with the highest amplitudes in the HoG) are both angular modes. At 1916, it is determined whether the number of modes to blend is greater than 1. If the number of modes to blend is not greater than 1, then at 1918, the DIMD predictor is determined by blending the one selected angular IPM and a non-angular intra coding mode such as the planar mode (e.g., with weights ⅔ and ⅓, respectively).

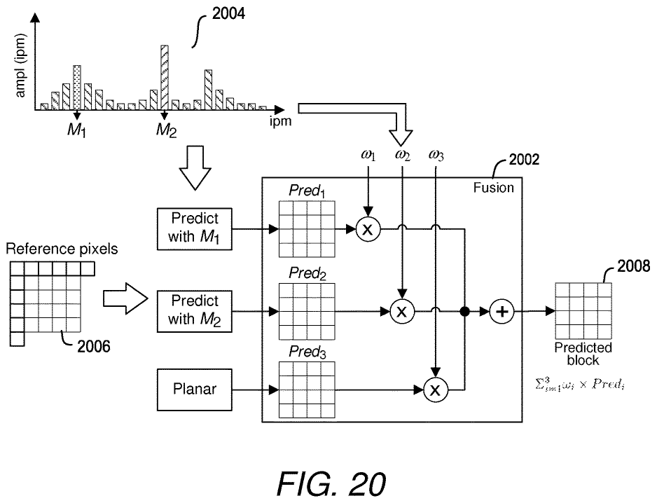

If at 1916, it is determined that the number of modes to be blended is greater than 1, then at 1920, blending weights of the selected IPMs are determined according to their amplitude ratios. In some examples, the multiple selected IPMs may be blended with a planar mode using a fixed weight (e.g., a weight of ¼). At 1922, a blended IPM is generated as the result of the blending of the selected IPMs (at 1914) and the planar mode. As described below in relation to FIG. 20, the blending of selected IPMs and the planar mode to derive the blended IPM for the current block may include computing all the selected IPMs and the planar mode using neighboring reconstructed samples.

In some implementations, the blended IPM determined at 1922 may be used as the DIMD predictor for the current block.

Alternatively, some implementations may further use location-dependent blending modes to derive the DIMD predictor. The blending weights determined at 1920 are uniformly applied to all samples in the predictor and may be referred to as “uniform weights.” For location-dependent blending, for example, at 1924, sample-based weights for a predictor (e.g., for each selected/identified DIMD IPM) are determined (e.g., computed) so that the average weight used within the current block is approximately equal to the corresponding uniform weight (e.g., calculated at 1920) such that higher weights are used in the portion of the current block closer to the left template region or the above template region, depending on the location dependency of the DIMD intra prediction mode. A range is predefined, corresponding to the largest deviation of sample-based weights from the corresponding uniform weight. Higher values of the predefined range result in a higher variation of the weights within the current block. After the blending weights for each location dependency (e.g., vertical, horizontal, or no location dependency) are calculated at 1924, the predictions associated with the respective location dependencies are blended at 1926. For example, for each of horizontal location dependency, vertical location dependency, and no location dependency (i.e., diagonal location dependency) that is used by any of the selected IPMs of the DIMD predictor, the selected IPMs having that location dependency are blended based on their respective amplitudes.

At 1928, the DIMD predictor is determined (e.g., obtained) by blending together the respective location dependency predictors (horizontal, vertical, no location dependency) in accordance with the respective sums of amplitudes of the selected IPMs in each location dependency. This provides a directional sample-wise blending depending on location dependency and using fixed weight derivation as calculated at 1924.

In example implementations, the DIMD intra prediction mode determined at 1922 or 1928 may be added to an MPM list along with other IPMs being considered for use on the current block. Subsequently, if it is determined, by a rate distortion optimization (RDO) cost calculation at the encoder, that the DIMD intra prediction mode is the best (i.e., most cost effective with, for example, lowest RDO cost), then the current block may be encoded using the DIMD intra prediction mode and only a flag indicating that the current block is encoded using DIMD is transmitted in the bitstream with the residual of the current block. The intra prediction mode(s) used in generating the DIMD intra prediction mode is not explicitly transmitted in the bitstream to the decoder.

In example implementations, up to a predetermined number (e.g., 4) angular IPMs are selected from the HoG and are combined (e.g., also referred to as blending or fusion) with the planar mode with weights derived from the ratio between amplitudes of selected IPMs, as described at 1920 and 1928. In an example, the planar mode may have a weight that is a ratio of ¼ or 16/64 with 6 bits integer precision.

FIG. 20 shows an example of combining (also referred to as “fusion” or “blending”) two IPMs (e.g., angular modes) from an HoG 2004 and a planar mode, according to some embodiments. The blending of two angular IPMs (e.g., IPMs M1 and M2) and the planar mode is shown. IPMs M1 and M2 are selected, from the HoG 2004 for the current block 2006, based on the highest two peaks (e.g., highest amplitudes) of the HoG 2004. The predicted block 2008 (also referred to as prediction block) for the current block 2006 is determined in a combining (fusion) operation 2002 that combines predictions based on intra modes M1 and M2 and the planar mode, based on weights w1, w2, and w3, respectively. The weights for the respective angular IPMs are determined according to the amplitudes of the corresponding gradients (e.g., angles) in the HoG 2004 and a predetermined weight may be used for the planar mode.

In some implementations, since derived IPMs are included into the MPM list, the DIMD process is performed before the MPM list is constructed. The primary derived IPM of a DIMD block may be stored with a block and is used for MPM list construction of the neighboring blocks. In some examples, when DIMD is signaled, MPM and MRL are not signaled and default values (e.g., 0's) may be assigned or implicitly derived.

In some implementations, another intra mode prediction technique proposes to merge the DIMD HoG information from neighboring blocks in order to predict the current block. When neighboring blocks encoded with DIMD or other intra prediction modes are available, the DIMD histogram information of the selected neighboring CUs are combined to form a merged histogram of gradients (MHoG) for the current block. DIMD modes and weights are derived from this merged histogram. The HoG of current block is not derived and not used in the construction of the MHoG.

The DIMD merge process is similar to the DIMD process that is described above in relation to FIGS. 19-20, and may differ from that process by including a set of operations that precedes 1910. In the proposed DIMD HoG merge process, at most a quantity (e.g., 3) neighboring CUs are selected from up to a quantity (e.g., 13) of neighboring CUs that are available, coded as intra DIMD, and that are spatially the closest to the current block. The HoG or merged HoG of the selected neighbor CUs are retrieved. A merged HoG is calculated from the HoG (or merged HoG) of the selected CUs. The blended modes are identified depending on the merged HoG in the same manner as described above in relation to DIMD. Up to a predetermined number (e.g., 5) of intra prediction modes are selected (e.g., based on the highest amplitudes in the merged HoG), as in the regular DIMD mode, and location dependency is determined. If multiple intra prediction modes are selected, the location dependency is set to 0 (diagonal), otherwise, the location dependency is set to the selected intra prediction mode's location dependency. The DIMD HoG merge mode intra prediction mode for the current block can be determined by combining the selected intra prediction modes.

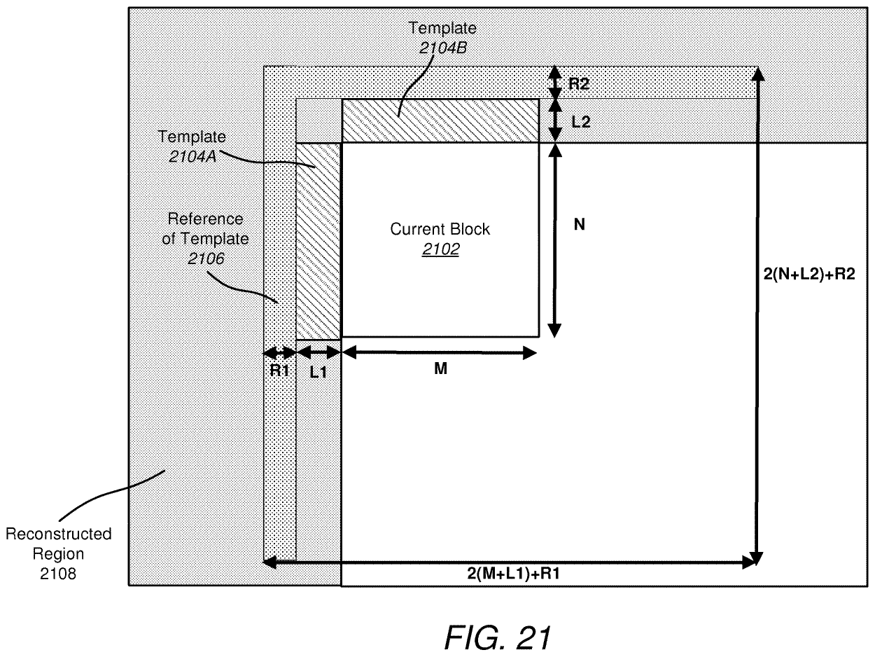

FIG. 21 shows an example of regions of reconstructed samples used in template-based intra mode derivation (TIMID) for coding a current block 2102 of M×N pixels, according to some embodiments. TIMD is a type of intra prediction in which an intra prediction mode (IPM) may be reciprocally determined (e.g., independently and identically derived) by an encoder (e.g., encoder 200) and a decoder (e.g., decoder 300) such that the IPM determined (e.g., selected) by the encoder (e.g., using a rate distortion optimization (RDO) algorithm) does not need to be explicitly signaled to the decoder. Hence, signaling bandwidth is reduced and TIMID may be considered as a type of decoder-side intra mode derivation process. In some implementations, TIMD usage is signaled with an indication (e.g., a syntax element such as a flag) at the CU level (e.g., per block) and the TIMD-derived intra prediction mode, when TIMD is enabled/activated, is derived during the reconstruction process identically at the encoder and decoder. If TIMD is not selected at the encoder, the intra mode may be parsed from the bitstream at the decoder as in intra modes where the intra prediction mode is signaled in the bitstream.

As shown in FIG. 21, for TIMD, a video coder (e.g., encoder 200 or decoder 300) may determine a template 2104 for current block 2102. Template 2104 may comprise one or more regions of samples in a reconstructed region 2108 of a current picture (or frame) of current block 2102. The one or more regions may include reconstructed samples neighboring (e.g., adjacent to) current block 2102. In some examples, the one or more regions of template 2104 may comprise a template region 2104A to the left of current block 2102 (e.g., a left template) and a template region 2104B above current block 2102 (e.g., an above template). In some examples, template 2104 may include a region that is above and/or to the left of current block 2102 (e.g., the region enclosed by reference of template 2106 and template regions 2104A-B). Template regions 2104A and 2104B may have a thickness (e.g., width and height respectively) of L1 and L2 samples, respectively. For example, L1 and/or L2 may be 2 samples, 4 samples, 8 samples, etc. Template region 2104A may have a height of N samples, which may be a height of current block 2102. Template region 2104B may have a width of M samples, which may be a width of current block 2102.

In TIMD, reference of template 2106 is used to derive a template predictor for template 2104. The video coder may determine (e.g., select and obtain) reference of template 2106 as a region of samples (in reconstructed region 2108) neighboring (e.g., adjacent to) template 2104. For example, reference of template 2106 may comprise reconstructed samples left and/or above template 2104. Reference of template 2106 may have a thickness to the left of template region 2104A of R1 samples and a thickness above template region 2104B of R2 samples. For example, R1 and/or R2 may be 1 sample. In some examples, similar to reference samples 902 being selected from a reference line of MRL as explained in FIG. 9, reference of template 2106 may include template reference samples selected from a template reference line of template MRL. Thus, reference of template 2106 may refer to a region of samples greater than 1 sample wide and be, e.g., 2 samples wide indicating two template reference lines, 4 samples indicating four template reference lines, etc. Additionally, when MRL is enabled, one of the reference lines may be selected as reference of template 2106 to be used in generating a prediction for template 2104A-B. As shown, reference of template 2106 may include an L-shaped region bordering template 2104.

In some examples, reference of template 2106 may include an upper region having a width greater than template region 2104B (e.g., a width that is greater or equal to twice the width of template region 2104B, 2(M+L1) samples, 2(M+L1)+R1 samples, etc.). In some examples, reference of template 2106 may include a left region having a height greater than template region 2104A (e.g., a height that is greater or equal to twice the height of template region 2104A, 2(N+L2) samples, 2(N+L2)+R2 samples, etc.).

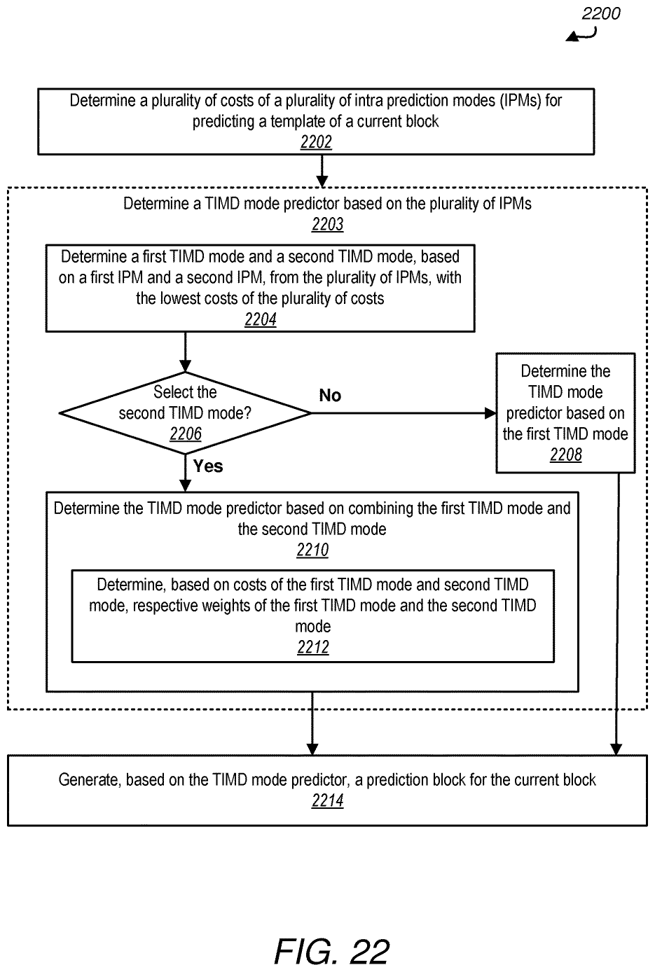

FIG. 22 shows a flowchart 2200 of an example TIMD process for determining a TIMD predictor for coding a current block 2102 of FIG. 21, according to some embodiments. The process of flowchart 2200 may be performed reciprocally and identically at the encoder (e.g., encoder 200 of FIG. 2) and the decoder (e.g., decoder 300 of FIG. 3) such that no intra modes need to be explicitly signaled by the encoder to the decoder in the bitstream.

At block 2202, the video coder determines a plurality of costs of a plurality of intra prediction modes (IPMs) for predicting a template of a current block. In some examples, the video coder may determine the plurality of costs based on TIMD being applied (e.g., enabled) for the current block. Each cost for a respective IPM, of the plurality of IPMs, is based on differences between: predicted samples, of a template, generated from the IPM applied to reference samples of the template; and reconstructed samples of the template. Examples of the template of the current block and the reference of the template are shown and described with respect to FIG. 21.

The one or more TIMD modes may be determined from a list of candidate intra prediction modes (IPMs). For example, the list may include IPMs from a most probable mode (MPM) list. In some examples, one or more of a DC mode, a planar mode, a horizontal and/or vertical DC mode, or a horizontal and/or vertical planar, may be added to the list of candidate IPMs. A cost (e.g., SAD, SSD, or SATD) for each candidate IPM in the list may be determined based on differences between reconstructed samples in template 2104 and predicted samples of template 2104 generated based on reference of template 2106 and using the candidate IPM. For example, the video coder may determine the predicted samples (of template 2104) by applying the candidate IPM to samples of reference of template 2106.

In some examples, the video coder may be a decoder that determines the plurality of costs based on receiving (e.g., parsing and decoding), from a bitstream, an indication of the TIMD being applied (e.g., enabled) for the current block. For example, an encoder may determine that TIMD is applied for coding the current block and signal the indication in the bitstream to the decoder. In some examples, the indication may be a syntax element (e.g., a flag such as timd_flag) that is activated and signaled in the bitstream at the block level (e.g., per block).

At block 2203, the video coder determines a TIMD mode predictor based on the plurality of IPMs. Block 2203 may comprise blocks 2204-2212.

At block 2204, the video coder determines a first TIMD mode and a second TIMD mode, based on a first IPM and a second IPM, from the plurality of IPMs in the list, with the lowest costs of the plurality of costs. For example, the first TIMD mode may have the lowest cost and the second TIMD mode may have the next lowest cost. In an example, the first and second TIMD modes are determined as the first and second IPMs, respectively.

In some examples, the first and second TIMD modes may be determined by refining the first and second IPMs. For example, an angular mode range may be extended from a first range of the list (e.g., 67 modes) to a second range (e.g., 131 modes) and costs of the two adjacent modes (i.e., +/−1 mode) of each selected IPM may be determined. For example, an index of the first IPM in the first range may be converted (e.g., mapped) to an index corresponding to the first IPM in the second range. For example, the first TIMD mode may be determined as an IPM having the smallest cost among costs of the first IPM and its two adjacent modes in the second range. The second TIMD mode may be determined as an IPM having the smallest cost among costs of the second IPM and its two adjacent modes in the second range.

At block 2206, the video coder determines whether to select the second TIMD mode to determine the TIMD mode predictor. In some embodiments, selection of the second TIMD mode (IPM₂) for the fusion process may be further based on comparing a cost (costIPM₁) of the first TIMD mode (IPM₁) against a threshold cost. In an example, the threshold cost may be a fixed value. In some examples, the threshold cost may be based on the first IPM cost. In an example, the threshold cost comprises scaling a cost of a selected TIMD mode (e.g., the first TIMD mode with the lowest cost) by a scaling factor a greater than 1. For example, the second TIMD mode (IPM₂) may be selected for blending in the fusion process if the following condition (21) is fulfilled:

costIPM₂<a·costIPM₁ (21)

where: a is greater than 1 (e.g., a may be a value in the range of 1 to 2); costIPM₂ is a cost (e.g., SATD, sum of squared error (SSE), SAD, etc.) of the second TIMD mode; and costIPM₁ is the cost of the first TIMD mode.

In some examples, the first TIMD mode is determined as the TIMD mode predictor (i.e., the TIMD mode predictor is derived only from the first TIMD mode, without fusion process of one or more additional TIMD modes), for example, based on condition (21) not being fulfilled. In these examples, the first TIMD mode was selected using reference samples from a template reference line with template MRL index #0 (i.e., reference line #0 adjacent to the template), but the TIMD predictor may be generated by applying the first TIMD mode to a different reference line index (e.g., with respect to the example MRL list described in FIG. 9, MRL index #1 would indicate reference line #1 adjacent to the current block and MRL index #2 would indicate reference line #3 adjacent to the current block) signaled in the bitstream. For example, during an encoder side rate-distortion optimization (RDO) check, the TIMID predictor generated with the reference line l from the MRL list providing the lowest RDO cost may be selected and signaled as the MRL index (indicating the reference line l in the MRL list) associated with the selected TIMID predictor.

At block 2208, based on the second TIMD mode not being selected, the video coder determines the TIMID mode predictor based on the first TIMID mode. For example, the TIMD mode predictor may be determined to be the first TIMID mode.

At block 2210, based on the second TIMD mode being selected, the video coder determines the TIMID mode predictor based on combining (e.g., blending or fusing) the first TIMID mode and the second TIMID mode. For example, the TIMD mode predictor may be a linear combination of the first TIMID mode and the second TIMID mode. Block 2210 may include block 2212.

In some embodiments, the first and second TIMID modes are determined based on reference samples from a same reference line neighboring template 2104 such as a reference line #0 (template reference line #0) that is immediately adjacent to template 2104. Similarly, template reference line #0 may correspond to template reference line index 0 and may be the closest template reference line (i.e., immediately adjacent) to template 2104.

In some embodiments, the TIMID mode predictor may be determined based on generating the first TIMD mode and the second TIMD mode. For example, the first TIMID mode may be generated by applying the first TIMID mode to reference samples from a reference line l (for instance l is reference line #0) in the neighborhood of current block 2102 and the second TIMD mode may be generated by applying the second TIMD mode to reference samples from either the same reference line (l) or another reference line (for instance i+1 where i+1 designates reference line #1) depending on a set of conditions. For example, reference line i+1 may be selected for generating the second TIMID mode based on the following being satisfied: the current block is not coded as an intra sub-partition (ISP) block, and the second TIMD mode is an angular prediction mode represented by fractional angles. Otherwise, the reference line l is selected for generating the second TIMID mode. Generally, reference samples used to generate the first and second TIMID modes are located in template 2104.

At block 2212, the video coder determines, based on costs of the first TIMD mode and second TIMID mode, respective weights of the first TIMD mode and the second TIMID mode in the linear combination.

In some examples, each weight of a TIMD mode may be determined as being inversely proportional to a cost of the TIMD mode such that a smaller cost (e.g., SSE, SSD, or SATD) is associated with a higher weight. In other words, the TIMD mode with the smaller cost will have a higher weight than that of the other TIMID mode with the higher cost. For example, a first weight (weight1) for the first TIMD mode with a first cost (costMode 1) and a second weight (weight2) for the second TIMD mode with a second cost (costMode2) may be determined as follows:

$$weight 1 = \frac{costMode 2}{costMode 1 + costMode 2} \qquad ( 22 )$$

$$weight 2 = 1 - weight 1 = \frac{costMode 1}{costMode 1 + costMode 2} \qquad ( 23 )$$

In some embodiments, weights (e.g., first and second weights) of the TIMD modes (e.g., first and second TIMD modes) selected to determine the TIMD mode predictor may be determined (e.g., computed) based on costs of the TIMD modes. For example, a weight for a TIMD mode may be determined to be inversely proportional to a cost for the TIMD mode and/or proportional to a difference between a sum of the costs and the cost of the TIMD mode. For example, the weights of the TIMD modes may be determined according to the following equation:

$${w}_{i} = \frac{{\sum }_{i = 1}^{n} {costIPM}_{i} - {costIPM}_{i}}{( n - 1 ) \times {\sum }_{i = 1}^{n} {costIPM}_{i}} \qquad ( 24 )$$

wᵢ is the weight associated with the i-th IPM of the i-th TIMD mode. costIPMᵢ is the cost associated with (e.g., determined for) the i-th IPM of the i-th TIMID mode. For example, w₁ represents the first weight of the first TIMD mode and w₂ represents the second weight of the second TIMD mode. n (e.g., 3, 4, etc.) represents the number of TIMD modes to be combined (i.e., in a linear combination with the weights) to generate the TIMD mode predictor.

It should be noted additional weights may be determined based on additional TIMD modes being blended. One or more TIMD modes may be selected and be determined/selected from an MPM list or other modes (e.g., DC, horizontal, vertical directions and extended IPM for wide angular IPM).

Thus, the TIMD mode predictor comprises a linear combination of a number of selected TIMD modes (e.g., the first and second TIMD modes are selected at 2204 and 2206) with corresponding weights. For example, the TIMD mode predictor (IPM_{TIMD}) may be determined according to the linear combination below:

$${IPM}_{TIMD} = {\sum }_{i = 1}^{n} {w}_{i} \times {IPM}_{i} \qquad ( 25 )$$

wᵢ may be the weight for an i-th TIMID mode comprising an i-th IPM.

At block 2214, the video coder generates, based on the TIMD mode predictor, a prediction block for the current block. For example, the video coder may apply the TIMD mode predictor to the template of the current block to generate the prediction block for the current block.

In some examples, when the video coder is a decoder, the decoder may reconstruct the current block based on the prediction block and a residual (e.g., a prediction error or a residual block). For example, the decoder may receive (e.g., decode) the residual from a bitstream.

In some examples, when the video coder is an encoder, the encoder may determine (e.g., generate) the residual based on a difference between the prediction block and current block. The encoder may encode the determined residual in the bitstream.

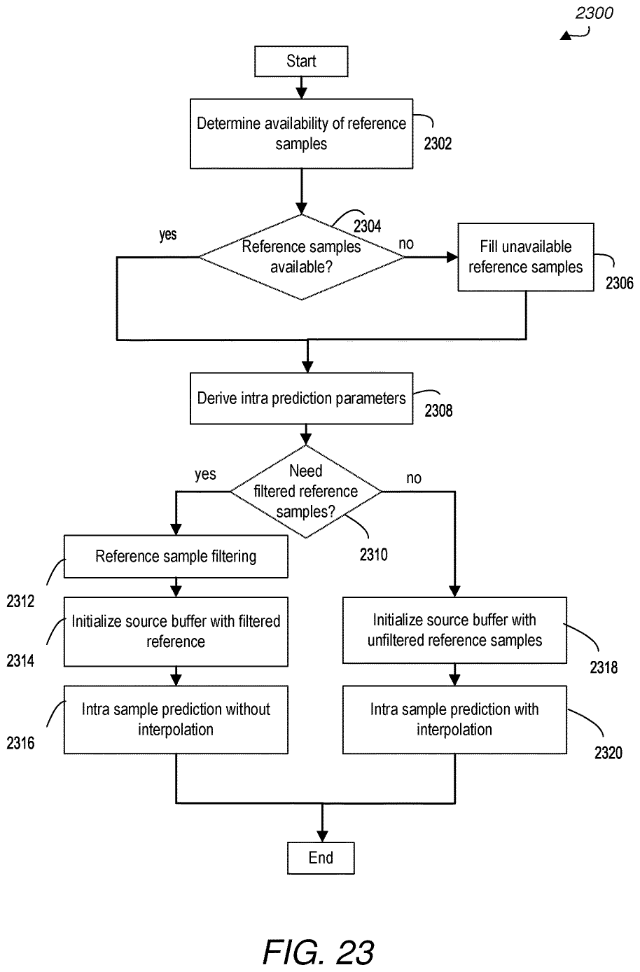

FIG. 23 shows a flowchart 2300 of an example method for predicting samples of a current block (e.g., current block 904 of FIG. 9 and FIG. 11), being encoded or being decoded, using an intra prediction mode such as those described above with respect to FIGS. 10-12, according to some embodiments. Specifically, flowchart 2300 relates to how reference samples in a template of the current block are obtained and, possibly, filtered before the intra prediction mode is applied to generate a prediction of the current block. The method of flowchart 2300 may be implemented by a video coder (e.g., encoder 200 in FIG. 2 or decoder 300 in FIG. 3).

The method of flowchart 2300 begins at block 2302. At block 2302, availability of reference samples (e.g., reference samples 902 of FIG. 9) in the template of the current block (e.g., current block 904 of FIG. 9 and FIG. 11) is determined, as described with respect to FIG. 9. In some examples, unavailable (or missing) reference samples of the reference samples may be marked (e.g., tagged) as being unavailable.

If, at block 2304, it is determined that some of reference samples 902 are unavailable, flowchart 2300 proceeds to block 2306. At block 2306, unavailable reference samples are filled, for example, using available neighboring reconstructed samples, as described above with respect to FIG. 9. In some examples, the unavailable reference samples may be substituted or replaced with a neighboring available reconstructed sample.

At block 2308, intra prediction parameters (e.g., intra prediction flags) for the current block are derived, as described above with respect to FIG. 9. For example, the intra prediction parameters may include: a first activation flag indicating whether reference samples smoothing is activated/selected/enabled, and include a second activation flag indicating whether the interpolation filtering is activated/selected/enabled. At block 2310, whether filtered reference samples are needed is determined. For example, the determination may be based on one or more conditions associated with characteristics or parameters of the current block. Such characteristics or parameters may include whether specific modes such as MRL or ISP modes are used, a size of the current block, an angle of the intra prediction mode, etc. Other conditions are described with respect to FIG. 9. If, at block 2310, it is determined that the reference samples are to be filtered, at block 2312, the reference samples are filtered. Then at block 2314, a source buffer of the intra sample prediction is initialized with the filtered reference samples. At block 2316, the filtered reference samples in the source buffer are processed using the intra prediction mode without interpolation filtering.

If, at block 2310, it is determined that the reference samples are not to be filtered, at block 2318, the source buffer, used for intra sample prediction, is initialized with the unfiltered reference samples. At block 2320, based on no filtering of reference samples being determined, the samples from the initialized source buffer of block 2318 are processed using the intra prediction mode with interpolation filtering, as described above with respect to FIGS. 11-12.

The reference samples described in flowchart 2300 are from at least one reference line, e.g., in the template of the current block. In some examples, the reference samples are from the immediately adjacent line to the current block. In some examples, when multiple reference lines are used such as by Multiple Reference Lines (MRL) coding mode/tool, the reference samples may be from a non-adjacent line to the current block. Further, in some examples, all missing samples of the one or more selected reference lines may be marked (e.g., at block 2302) and filled (e.g., at block 2306), and if required to be filtered, all reference line may be filtered (e.g., at block 2312).

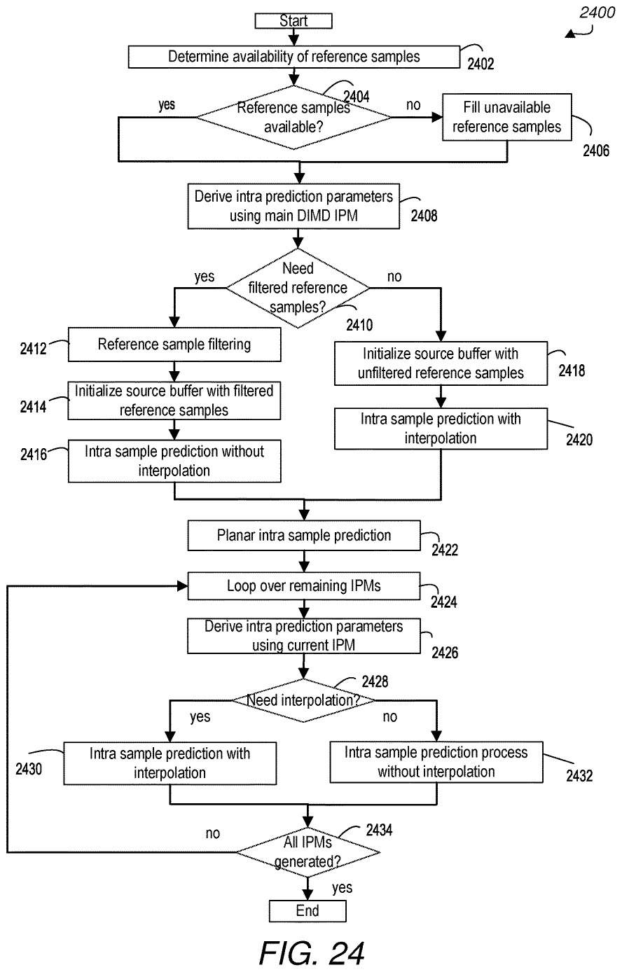

FIG. 24 shows a flowchart 2400 of an example method for generating a plurality of selected intra prediction modes combined in a fusion or blending process to determine a DIMD predictor for predicting samples (e.g., generating a prediction block) of a current block (e.g., current block 904 of FIG. 9 and FIG. 11), according to some embodiments. Flowchart 2400 may provide an example process for generating the blended IPM and corresponds to block 1922 of FIG. 19. DIMD fusion is further explained above with respect to FIGS. 18-20. The method of flowchart 2400 may be implemented by a video coder (e.g., encoder 200 in FIG. 2 or decoder 300 in FIG. 3). Many operations of flowchart 2400 are the same as those in flowchart 2300 of FIG. 23.

The method of flowchart 2400 begins at block 2402. At block 2402, unavailable (e.g., missing) reference samples (e.g., reference samples 902) are determined similar to block 2302. If, at block 2404, it is determined that some of the reference samples are unavailable, they are filled at block 2406 using the same process as described in block 2306. At block 2408, based on the current block, the intra prediction parameters (e.g., intra prediction flags such as usage of the reference samples smoothing and the interpolation filtering) are derived similar to block 2308. These intra prediction parameters may be derived using the main (e.g., first/primary) DIMD IPM, as explained in FIGS. 18-19. If, at block 2410, which is similar to block 2310, it is determined that the reference samples are to be filtered, at blocks 2412, 2414, and 2416, the reference samples are filtered, set (e.g., added to) as the source buffer of the intra sample prediction, and the samples of the initialized source buffer are processed without interpolation filtering, respectively. Blocks 2412-2416 correspond to blocks 2312-2316, respectively.

In some examples, the reference samples may be from several reference lines.

If, at block 2410, it is determined that the reference samples are not to be filtered, at blocks 2418 and 2420, the unfiltered reference sample are defined as the source buffer of the intra sample prediction and then processed with interpolation filtering. Blocks 2418-2420 correspond to blocks 2318-2320, respectively.

At block 2422, the intra prediction for the planar mode is generated using the reference samples (from the source buffer), as described with respect to FIG. 11. At block 2424, the intra prediction of the remaining IPMs (if present) are processed. At block 2426, the intra prediction parameters of the current IPM are derived in a similar manner as at block 2408. If, at block 2428, it is determined that the current IPM of the current block requires interpolation filtering, the intra sample prediction uses interpolation at block 2430. If, at block 2428, it is determined that the current IPM of the current block does not require interpolation filtering, the intra sample prediction does not use interpolation filtering at block 2432. If, at block 2434, it is determined that the current block has a further intra prediction mode, blocks 2424 to 2434 are repeated for the next intra prediction mode of the current block.

In implementations of DIMD predictor generation, additional IPMs may use reference samples from one of the initialized buffer sample of block 2414 or 2418, depending on derived intra prediction parameters of the main DIMD IPM, independent of whether interpolation is determined to be needed at block 2428 for each of the additional IPMs.

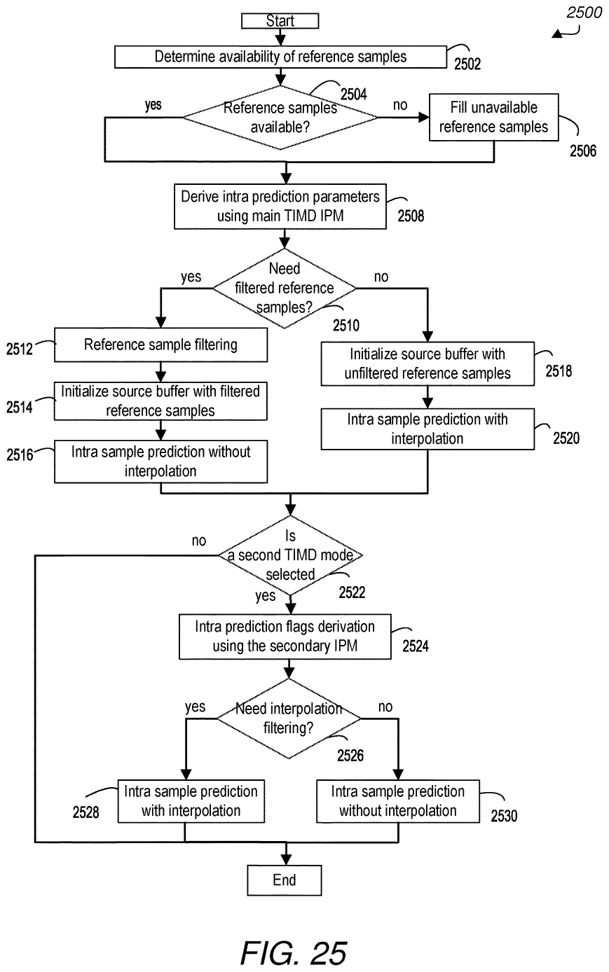

FIG. 25 shows a flowchart 2500 of an example method for generating a TIMD predictor including one or more selected TIMD modes, according to some embodiments. Flowchart 2500 may provide an example process for generating the TIMD mode predictor described with respect to block 2210 of FIG. 22. The method of flowchart 2500 may be implemented by a video coder (e.g., encoder 200 in FIG. 2 or decoder 300 in FIG. 3). Many operations of flowchart 2500 are the same or similar to those in flowchart 2300 of FIG. 23.

The method of flowchart 2500 begins at block 2502. At block 2502, unavailable (e.g., missing) reference samples (e.g., reference samples 902) are determined similar to block 2302. If, at block 2504, it is determined that some of the reference samples are unavailable, they are filled at block 2506 using the same process as described in block 2306. At block 2508, based on the current block, the intra prediction parameters (e.g., intra prediction flags such as usage of the reference samples smoothing and the interpolation filtering) are derived similar to block 2308. Different from block 2308, these intra prediction parameters of block 2508 may be derived using the main (e.g., first/primary) TIMD IPM, as explained with respect to FIGS. 21-22. If, at block 2510, which is similar to block 2310, it is determined that the reference samples are to be filtered, at blocks 2512, 2514, and 2516, the reference samples are filtered, set (e.g., added to) as the source buffer of the intra sample prediction, and the samples of the initialized source buffer are processed without interpolation filtering, respectively. Blocks 2512-2516 correspond to blocks 2312-2316, respectively.

In some examples, the reference samples may be from several reference lines.

If, at block 2510, it is determined that the reference samples are not to be filtered, at blocks 2518 and 2520, the unfiltered reference samples are defined as source buffer of the intra sample prediction and then processed with interpolation filtering. Blocks 2518-2520 correspond to blocks 2318-2320, respectively.

If, at block 2522, it is determined that the TIMD predictor of the current block is generated with a second IPM, the intra prediction parameters of the second IPM of the current block are derived at block 2524. One or more conditions may be evaluated to determine whether the second IPM is used to select a second TIMD mode to determine the TIMD predictor, as described above with respect to FIG. 22.

If at block 2526, it is determined that the current IPM of the current block requires interpolation filtering, the intra sample prediction is generated using the current IPM with interpolation at block 2528. Otherwise, if it is determined that the current IPM does not require interpolation filtering at block 2526, the intra sample prediction is generated using the current IPM without interpolation at block 2530. Blocks 2524 to 2530 may correspond to block 2210 described above with respect to FIG. 22.

If, at block 2522, it is determined that the TIMD predictor of the current block does not have a second IPM, flowchart 2500 ends.

In implementations of TIMD predictor generation, one or more additional IPMs, such as the second TIMD mode, may use reference samples from one of the initialized buffer sample of block 2514 or 2518, depending on derived intra prediction parameters of the main TIMD IPM, independent of whether interpolation is determined to be needed at block 2526 for each of the additional IPMs.

Decoder-side intra mode derivation (DIMD) and template-based intra mode derivation (TIMD) are useful coding tools at least partly because they can reduce the amount of information that is required to be signaled from the encoder to the decoder. However, both intra modes derive their intra prediction modes and weights from a restricted area of the reconstructed neighboring samples of the current block to be coded. The restricted area may be a template region (also referred to as template area or simply template) of the current block and may be small (e.g., has few samples) compared to a size of the current block. This restriction on the template size may often not yield the best neighboring reconstructed samples since the further from the template area the current block samples are, the less likely it is that the spatial correlation between the template and the current block is high. Accordingly, the use of these intra modes to predict samples of the current template using the reference samples in the template may be less accurate.

In implementations intra coding, to increase prediction accuracy, a smoothing filter or an interpolation filter may be selectively applied on the reference samples depending on the intra modes, which may include TIMD-based and DIMD-based intra modes. In current implementations of TIMD predictor generation (e.g., described in FIG. 25) and DIMD predictor generation (e.g., described in FIG. 24), the predicted samples derived by TIMD-based and DIMD-based modes use reference samples, from a source buffer, that may be filtered or unfiltered reference samples depending on the main mode, e.g., the IPM (e.g., TIMD mode) with the lowest template cost in the case of the TIMD or the IPM (e.g., DIMD mode) with the highest amplitude in the case of the DIMD. For example, depending on the main or primary IPM, the source buffer may be initialized with filtered reference samples. Then, for each IPM to be blended to generate in the DIMD or TIMD fusion process, it is determined whether interpolation filtering is to be performed on the samples in the source buffer, which have been filtered already. Accordingly, TIMD-based or DIMD-based predictors can be generated using IPMs that have both the reference sample smoothing and the interpolation filtering performed. Applying both filter types may reduce the benefits provided by each of the filters separately and may reduce the accuracy of both TIMD and DIMD predictors.

Furthermore, regarding the DIMD-based process that requires the generation of the planar prediction, the source buffer used in the planar sample prediction can be inaccurate when, for example, filtered reference samples are used or when unfiltered reference samples are expected, and vice versa.

These drawbacks may result in compromising the reliability and compression of DIMD-based and TIMD-based predictors compared to other intra modes. Embodiments are described that relate to an approach for improved DIMD-based and TIMD-based modes that can increase accuracy and reliability of these intra modes. These and other features of the present disclosure are described further below.

The intra prediction processes, which were described above, may provide 67 intra prediction modes (e.g., planar, DC, and 65 angular directions) for each prediction block. A luma intra prediction mode is selected for a luma prediction block and a chroma intra prediction mode is selected for the chroma prediction blocks. Mode-dependent reference and prediction sample smoothing is applied to increase prediction efficiency and the intra prediction mode is coded using either one of the 6 most probable modes (MPM) or one of the 61 remaining modes. It is noted that, in some examples, 28 wide angular modes (for rectangular CU only) can be used instead of or in addition to the regular modes.

Example embodiments of this disclosure provide a technique for a decoder, or an encoder, to efficiently derive the intra prediction mode to be applied to the current block without having it signaled from the encoder. More specifically, the technique ensures that the intra prediction principle is respected regarding TIMD-based and DIMD-based predictors by avoiding inconsistencies such as using conflicting filters such as the reference sample smoothing and the interpolation filtering used in the intra prediction.

For each block (e.g., CU) predicted using TIMD-based or DIMD-based prediction, like the TIMD, the DIMD, or the DIMD merge mode, embodiments include adapting the usage of filtered or unfiltered reference samples in combination with whether interpolation filtering is applied depending on each intra prediction mode.

In some embodiments, the intra mode prediction process described in this disclosure may be defined and applied to all predictions, either for a unidirectional prediction, or for modes including multiple intra predictions, for example, like the TIMD-based or DIMD-based prediction. This unique process ensures that the original principle of not combining the reference sample smoothing and the interpolation filtering is applied for all intra predictions. This technique is adaptive and follows the intra-prediction principle using the same process for each intra prediction mode without any distinction.

In some embodiments, the interpolation filtering used in the intra prediction process is adaptively disabled according to the TIMD-based or DIMD-based main intra prediction mode, that drives the usage of filtered or unfiltered reference samples. This technique ensures that the reference sample smoothing (e.g., filtering reference samples) and the interpolation filtering are not used in combination to derive a given intra prediction mode.

These techniques have the benefit of increasing the accuracy of TIMD-based and DIMD-based modes by ensuring that multiple types of filtering are not applied for the same IPM to derive intra prediction. Furthermore, it ensures a unique process to derive DIMD-based and TIMD-based predictors with very low complexity.

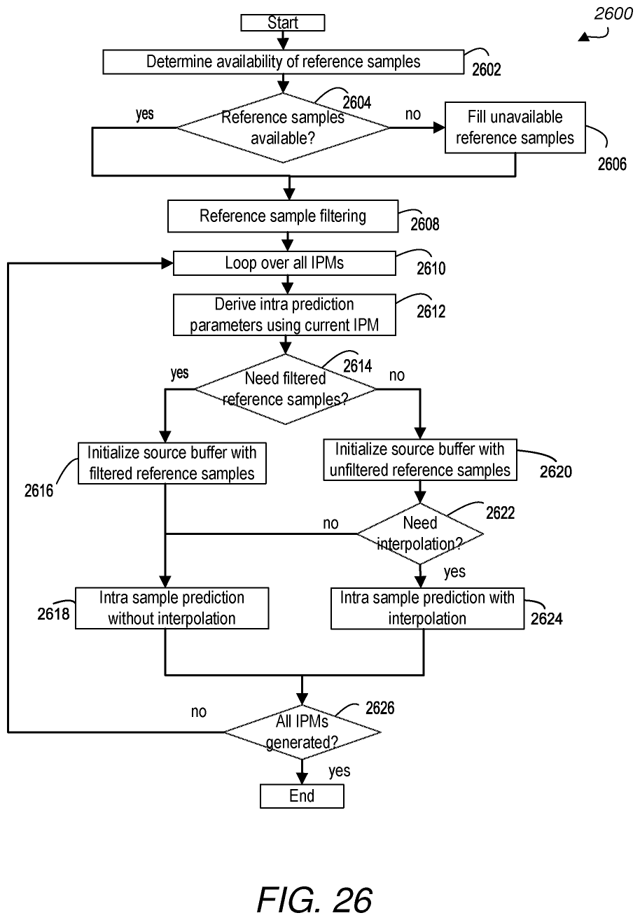

FIG. 26 shows a flowchart 2600 of an example method for encoding or decoding a current block (e.g., current block 1802 of FIG. 18, current block 2006 of FIG. 20, or current block 2102 of FIG. 21) with a DIMD-based or TIMD-based mode, according to some embodiments. Specifically, flowchart 2600 shows operations for deriving and processing reference samples used by intra prediction modes to generate a TIMD-based or DIMD-based predictor. The method of flowchart 2600 may be implemented by a video coder (e.g., encoder 200 in FIG. 2 or decoder 300 in FIG. 3). Some operations of flowchart 2600 are the same as those in flowchart 2300 of FIG. 23. In some embodiments, the method of flowchart 2600 comprises the reference sample derivation process in which obtained reference samples (e.g., from a template of the current block) are used to store unfiltered reference samples and filtered reference samples in separate buffers (e.g., arrays), followed by one or more directional intra prediction mode generations, as will be further explained below.

The method begins at block 2602, in which availability of reference samples (e.g., reference samples 902) in the template of the current block are determined. For example, one or more unavailable (e.g., missing) reference samples may be marked (e.g., tagged). Block 2602 may correspond to block 2302 of FIG. 23. As described with respect to FIG. 9, the reference samples may be from one or more reference lines in the case of MRL. If, at block 2604, it is determined that at least a portion of the reference samples are unavailable, at block 2606, the unavailable reference samples may be filled (or substituted with available samples), as described above with respect to FIG. 9 and block 2306 of FIG. 23.

At block 2608, reference sample smoothing (e.g., also referred to as reference filtering) is applied to the reference samples, and the filtered reference samples are stored in a dedicated buffer, to make both the unfiltered and filtered reference samples available for the following intra prediction modes generation process. In some examples, the reference samples initially obtained from the template are unfiltered and may be stored in a first buffer and the filtered reference samples may be stored in a second buffer separate from the first buffer.

In some embodiments, the reference sample smoothing at block 2608 can be processed even if filtered reference samples will not be subsequently used by any of the IPMs of the current block mode (e.g., a DIMD-based mode or a TIMD-based mode). To avoid unnecessarily filtering the reference samples, the reference sample smoothing at block 2608 may be conditioned based on analysis of the intra prediction parameters of all the intra prediction modes of the current block. For example, for a given block using DIMD or TIMD, with various intra prediction modes, the intra prediction parameters derivation, such as at block 2612, may be derived before the reference sample smoothing at block 2608, to determine whether any of the IPMs will use the filtered reference samples. If none of the IPMs of the current block require the filtered reference samples, block 2608 may be bypassed.

At block 2610, an iterative process is performed to derive the prediction of all intra prediction modes used in the DIMD-based or TIMD-based predictor generation for the current block. For example, in DIMD, two or more IPMs may be determined for determining DIMD modes to generate a DIMD predictor, as described with respect to FIGS. 19-20. For example, in TIMD, two or more IPMs may be determined for determining TIMD modes to generate a TIMD predictor, as described with respect to FIGS. 21-22. This iterative process begins at block 2610 and may include several operations such as those at blocks 2612-2626.

At block 2612, the intra prediction parameters for the current intra prediction mode (IPM) are derived. The intra prediction parameters include flags that indicate or specify the usage/activation/enabling of each of the reference sample smoothing (i.e., reference filtering) and the interpolation filtering. For example, it is determined whether reference sample smoothing is activated and it is determined whether interpolation filtering is activated. The operation of block 2612 may be similar to that of block 2308 of FIG. 23.

If, at block 2614, it is determined that the current IPM of the current block requires filtered reference samples, flowchart 2600 proceeds to block 2616. At block 2616, the source buffer used to derive the intra prediction is initialized with filtered reference samples. For example, the source buffer may be initialized with filtered reference samples from the second buffer described at block 2608. At block 2618, the intra sample prediction is processed using the defined source buffer without interpolation.

If, at block 2614, it is determined that the current intra prediction mode of the current block requires unfiltered reference samples, flowchart 2600 proceeds to block 2620. At block 2620, the source buffer used to derive the intra prediction is initialized with unfiltered reference samples, such as from the first buffer described with respect to block 2608. At block 2622, if it is determined that interpolation filtering is not to be applied, flowchart 2600 proceeds to block 2618, in which the intra sample prediction without interpolation is processed. At block 2622, if it is determined that the interpolation filtering is to be applied, the intra sample prediction with interpolation is processed at block 2624.

If, at block 2626, it is determined that the current block has further intra prediction of IPMs to derive, the operations of blocks 2610-2626 are repeated using the next intra prediction mode of the current block. Each of the intra prediction modes are iterated in similar fashion until they are generated and used to generate, for example, a TIMD predictor or a DIMD predictor for coding the current block.

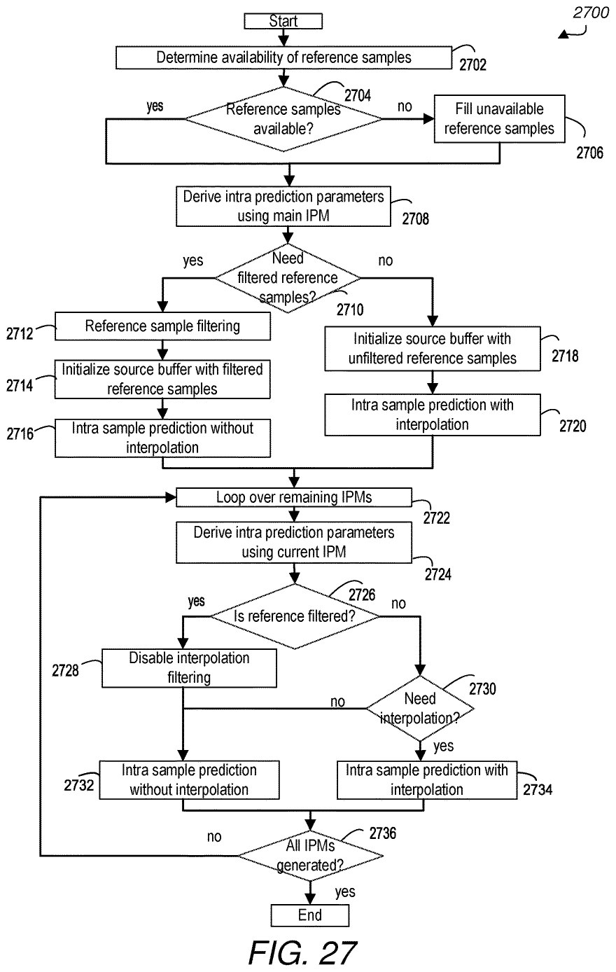

FIG. 27 shows a flowchart 2700 of an example method to generate or process intra prediction modes, used in TIMD-based or DIMD-based predictors for encoding or decoding a current block (e.g., current block 1802 of FIG. 18, current block 2006 of FIG. 20, or current block 2102 of FIG. 21), while ensuring that the interpolation filtering is not applied on already filtered reference samples, according to some embodiments. This method proposes to adaptively disable the interpolation filtering, according to the TIMD-based or DIMD-based main intra prediction, which drives the usage of filtered or unfiltered reference samples. The method of flowchart 2700 may be implemented by a video coder (e.g., encoder 200 in FIG. 2 or decoder 300 in FIG. 3). Some operations of flowchart 2700 are the same as those in flowchart 2300 of FIG. 23, flowchart 2400 of FIG. 24, and flowchart 2500 of FIG. 25.

The method begins at block 2702, in which availability of reference samples (e.g., reference samples 902) in the template of the current block are determined. For example, one or more unavailable (e.g., missing) reference samples may be marked (e.g., tagged). Block 2702 may correspond to block 2302 of FIG. 23. As described with respect to FIG. 9, the reference samples may be from one or more reference lines in the case of MRL. If, at block 2704, it is determined that at least a portion of the reference samples are unavailable, at block 2706, the unavailable reference samples may be filled (or substituted with available samples), as described above with respect to FIG. 9 and block 2306 of FIG. 23.

At block 2708, the intra prediction parameters (e.g., intra prediction flags such as usage of the reference samples smoothing and the interpolation filtering) for the main intra prediction mode of the current block are derived, similar to block 2508. For example, the main mode may be the IPM (e.g., TIMD mode) with the lowest template cost in the case of the TIMD or the IPM (e.g., DIMD mode) with the highest amplitude in the case of the DIMD.

If, at block 2710, which is similar to block 2310, it is determined that the main intra prediction mode of the current block requires filtered reference samples, operations of blocks 2712-2716 are processed. At block 2712, the reference sample smoothing is applied, and the filtered reference samples are stored in a dedicated buffer (e.g., a second buffer different from a first buffer storing unfiltered reference samples), to make both the unfiltered and filtered reference samples available for the following intra prediction modes generation process. At block 2714, the source buffer used to derive the intra prediction is initialized with filtered reference samples. At 2716, the intra sample prediction without interpolation is processed for the main IPM.

If, at block 2710, it is determined that the main intra prediction mode of the current block requires unfiltered reference samples, operations of blocks 2718-2720 are processed. At block 2718, the source buffer used to derive the intra prediction is initialized with unfiltered reference samples. At 2720, the intra sample prediction with interpolation is processed for the main IPM.

At block 2722, an iterative process is performed to derive the prediction of all remaining intra prediction modes used in the DIMD-based or TIMD-based predictor generation for the current block. For example, in DIMD, two or more IPMs may be determined for determining DIMD modes to generate a DIMD predictor, as described with respect to FIGS. 19-20. For example, in TIMD, two or more IPMs may be determined for determining TIMD modes to generate a TIMD predictor, as described with respect to FIGS. 21-22. This iterative process begins at block 2722 and may include several operations such as those at blocks 2724-2726.

At block 2724, the intra prediction parameters of the current intra prediction mode (of the remaining intra prediction modes) are derived, which may be similar to the operation performed at block 2708. The intra prediction parameters include flags that indicates or specifies the usage/activation/enabling of each of the reference sample smoothing (i.e., reference filtering) and the interpolation filtering.

If, at block 2726, it is determined that the main intra prediction mode of the current block requires filtered reference samples (e.g., the yes branch of block 2710), at block 2728, the interpolation filtering flag is set to disabled to ensure that it is not applied in combination with filtered reference samples. Then, at block 2732, the intra sample prediction without interpolation filtering is processed using filtered reference samples as defined by the main intra prediction block.

If, at block 2726, it is determined that the main intra prediction mode of the current block requires unfiltered reference samples (e.g., the no branch of block 2710), flowchart 2700 proceeds to block 2730, at which it is determined whether interpolation filtering of the reference samples is to be applied for the current IPM.

If, at block 2730, it is determined that the current intra prediction mode of the current block does not require interpolation filtering, flowchart 2700 proceeds to block 2732, in which the intra sample prediction without interpolation is processed using unfiltered reference samples.

If, at block 2730, it is determined that the current intra prediction mode of the current block requires interpolation filtering, at block 2734, the intra sample prediction with interpolation filtering is processed using unfiltered reference samples.

If, at block 2736, it is determined that the current block has further intra prediction of IPMs to derive, the operations of blocks 2722-2736 are repeated using the next intra prediction mode of the current block. Each of the intra prediction modes are iterated in similar fashion until they are generated and used to generate, for example, a TIMD predictor or a DIMD predictor for coding the current block.

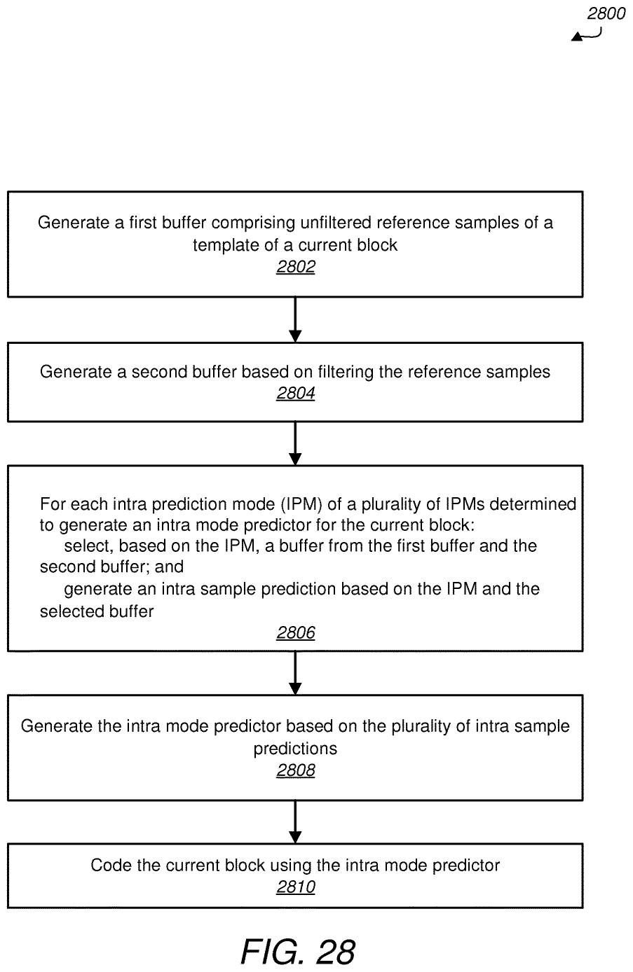

FIG. 28 shows a flowchart 2800 of an example method to process intra prediction modes (IPMs) used to generate an intra mode predictor (e.g., a TIMD-based or DIMD-based predictor) for encoding or decoding a current block (e.g., current block 1802 of FIG. 18, current block 2006 of FIG. 20, or current block 2102 of FIG. 21), according to some embodiments. The method of flowchart 2800 may be implemented by a video coder (e.g., encoder 200 in FIG. 2 or decoder 300 in FIG. 3).

At block 2802, a first buffer is generated comprising unfiltered reference samples of a template of a current block. In some examples, the reference samples may be obtained from the template, as described above with respect to FIG. 9 and blocks 2602-2606 of FIG. 26. Examples of the template are further described with respect to FIGS. 9, 11, 12, and 21. Block 2802 may correspond to block 2608 of FIG. 26.

At block 2804, a second buffer is generated based on filtering the reference samples. In some examples, the unfiltered reference samples stored in the first buffer may be filtered, for example, by applying a reference sample smoothing filter to the reference samples, as described above with respect to block 2608 of FIG. 26.

At block 2806, for each intra prediction mode (IPM) of a plurality of IPMs determined to generate an intra mode predictor for the current block: a buffer is selected, from the first buffer and the second buffer, based on the IPM; and an intra sample prediction is generated based on the IPM and the selected buffer. In some examples, the intra mode predictor may be a DIMD-based mode predictor, as further explained with respect to FIGS. 18-20. In some examples, the intra mode predictor may be a TIMID-based mode predictor, as further explained with respect to FIGS. 21-22.

In some examples, the buffer may be selected based on intra prediction parameters derived for each IPM, as described with respect to blocks 2612, 2616, and 2620 of FIG. 26. For example, the intra prediction parameters may include a first flag indicating whether reference filtering is enabled/activated/selected and a second flag indication whether interpolation filtering is enabled/activated/selected. These intra prediction parameters may be determined according to one or more conditions as described above with respect to FIG. 9.

In some examples, the intra sample prediction may be generated based on applying the IPM to samples of the selected buffer, which may include unfiltered or filtered reference samples depending on which of the first and second buffer is selected.

At block 2808, the intra mode predictor is generated based on the plurality of intra sample predictions. In some examples, the intra mode predictor may be a DIMD-based mode predictor, as explained above with respect to FIGS. 18-20. In some examples, the intra mode predictor may be a TIMD-based mode predictor, as further explained with respect to FIGS. 21-22.

At block 2810, the current block is coded using the intra mode predictor. In some examples, the intra mode predictor is used to generate a prediction block of the current block. The prediction block includes predicted samples, of the current block, generated based on the intra mode predictor. As explained above, depending on the type of intra predictions, the intra mode predictor may comprise a combination (e.g., blending or fusion) of a plurality of IPMs.

In some examples, on the encoder side, the encoder determines a residual based on a difference between the current block and the prediction block. Then, the encoder may signal the residual in a bitstream to the decoder. At the decoder side, the decoder decodes the residual from the bitstream. Like the encoder, the decoder identically determines the prediction block and may decode (e.g., reconstruct) the current block based on adding the residual to the prediction block.

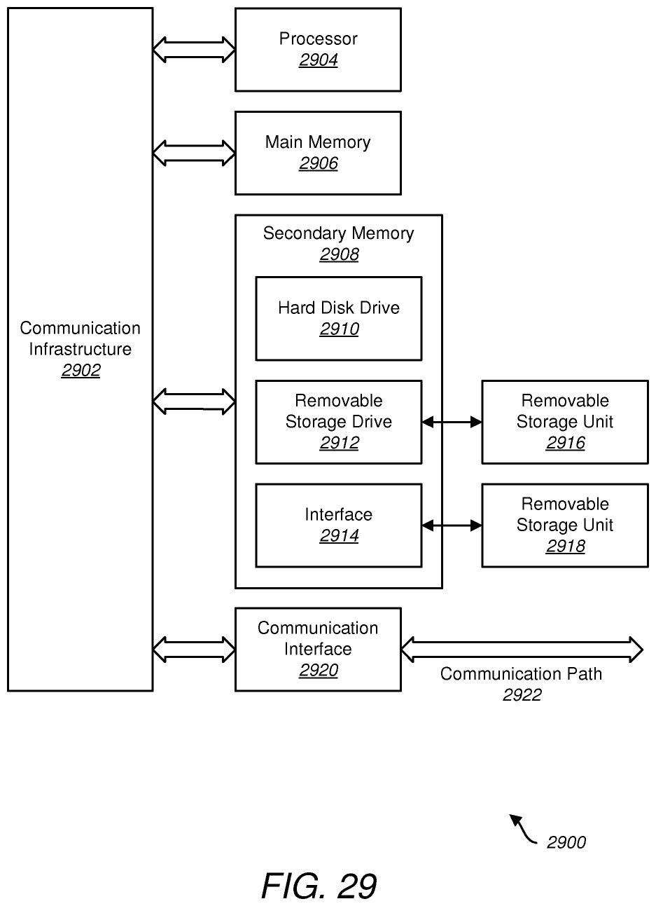

Embodiments of the present disclosure may be implemented in hardware using analog and/or digital circuits, in software, through the execution of instructions by one or more general purpose or special-purpose processors, or as a combination of hardware and software. Consequently, embodiments of the disclosure may be implemented in the environment of a computer system or other processing system. An example of such a computer system 2900 is shown in FIG. 29. Blocks depicted in the figures above, such as the blocks in FIGS. 1, 2, and 3, may execute on one or more computer systems 2900. Furthermore, each of the steps of the flowcharts depicted in this disclosure may be implemented on one or more computer systems 2900.

Computer system 2900 includes one or more processors, such as processor 2904. Processor 2904 may be, for example, a special purpose processor, general purpose processor, microprocessor, or digital signal processor. Processor 2904 may be connected to a communication infrastructure 2902 (for example, a bus or network). Computer system 2900 may also include a main memory 2906, such as random access memory (RAM), and may also include a secondary memory 2908.

Secondary memory 2908 may include, for example, a hard disk drive 2910 and/or a removable storage drive 2912, representing a magnetic tape drive, an optical disk drive, or the like. Removable storage drive 2912 may read from and/or write to a removable storage unit 2916 in a well-known manner. Removable storage unit 2916 represents a magnetic tape, optical disk, or the like, which is read by and written to by removable storage drive 2912. As will be appreciated by persons skilled in the relevant art(s), removable storage unit 2916 includes a computer usable storage medium having stored therein computer software and/or data.

In alternative implementations, secondary memory 2908 may include other similar means for allowing computer programs or other instructions to be loaded into computer system 2900. Such means may include, for example, a removable storage unit 2918 and an interface 2914. Examples of such means may include a program cartridge and cartridge interface (such as that found in video game devices), a removable memory chip (such as an EPROM or PROM) and associated socket, a thumb drive and USB port, and other removable storage units 2918 and interfaces 2914 which allow software and data to be transferred from removable storage unit 2918 to computer system 2900.

Computer system 2900 may also include a communications interface 2920. Communications interface 2920 allows software and data to be transferred between computer system 2900 and external devices. Examples of communications interface 2920 may include a modem, a network interface (such as an Ethernet card), a communications port, etc. Software and data transferred via communications interface 2920 are in the form of signals which may be electronic, electromagnetic, optical, or other signals capable of being received by communications interface 2920. These signals are provided to communications interface 2920 via a communications path 2922. Communications path 2922 carries signals and may be implemented using wire or cable, fiber optics, a phone line, a cellular phone link, an RF link, and other communications channels.

As used herein, the terms “computer program medium” and “computer readable medium” are used to refer to tangible storage media, such as removable storage units 2916 and 2918 or a hard disk installed in hard disk drive 2910. These computer program products are means for providing software to computer system 2900. Computer programs (also called computer control logic) may be stored in main memory 2906 and/or secondary memory 2908. Computer programs may also be received via communications interface 2920. Such computer programs, when executed, enable the computer system 2900 to implement the present disclosure as discussed herein. In particular, the computer programs, when executed, enable processor 2904 to implement the processes of the present disclosure, such as any of the methods described herein. Accordingly, such computer programs represent controllers of the computer system 2900.

In another embodiment, features of the disclosure may be implemented in hardware using, for example, hardware components such as application-specific integrated circuits (ASICs) and gate arrays. Implementation of a hardware state machine to perform the functions described herein will also be apparent to persons skilled in the art.

What is claimed is:

1. A method comprising:
generating a first buffer comprising unfiltered reference samples obtained from reference samples of a reference template of a current block;
generating a second buffer comprising filtered reference samples obtained by filtering the reference samples;
for each intra prediction mode (IPM) of a plurality of IPMs selected to generate a blended prediction block for the current block:
selecting, based on the IPM, a buffer from the first buffer and the second buffer; and
generating a respective prediction block for the current block based on the IPM and the selected buffer;
blending the plurality of prediction blocks to generate the blended prediction block; and
coding the current block using the blended prediction block.

2. The method of claim 1, wherein the filtered reference samples are obtained by applying a smoothing filter to the reference samples.

3. The method of claim 1, wherein the second buffer is generated based on determining that at least one IPM of the plurality of IPMs requires filtered reference samples.

4. The method of claim 1, wherein the buffer is selected based on intra prediction parameters associated with the IPM, the intra prediction parameters indicating whether filtered reference samples are used.

5. The method of claim 4, wherein the intra prediction parameters comprise one or more flags indicating whether reference sample smoothing or interpolation filtering is enabled or activated.

6. The method of claim 1, wherein, based on the selected buffer being the first buffer, the method further comprises:
determining whether interpolation filtering is activated for the IPM; and
generating the prediction block based on one of:
the unfiltered samples of the first buffer when the interpolation filtering is determined to not be activated; and
interpolated unfiltered samples of the first buffer when the interpolation filtering is determined to be activated.

7. The method of claim 1, wherein the plurality of prediction blocks are blended with a plurality of respective weights associated with the plurality of IPMs.

8. A decoder comprising:
one or more processors; and
memory storing instructions that, when executed by the one or more processors, cause the decoder to:
generate a first buffer comprising unfiltered reference samples obtained from reference samples of a reference template of a current block;
generate a second buffer comprising filtered reference samples obtained by filtering the reference samples;
for each intra prediction mode (IPM) of a plurality of IPMs selected to generate a blended prediction block for the current block:
select, based on the IPM, a buffer from the first buffer and the second buffer; and
generate a respective prediction block for the current block based on the IPM and the selected buffer;
blend the plurality of prediction blocks to generate the blended prediction block; and
code the current block using the blended prediction block.

9. The decoder of claim 8, wherein the filtered reference samples are obtained by applying a smoothing filter to the reference samples.

10. The decoder of claim 8, wherein the second buffer is generated based on determining that at least one IPM of the plurality of IPMs requires filtered reference samples.

11. The decoder of claim 8, wherein the buffer is selected based on intra prediction parameters associated with the IPM, the intra prediction parameters indicating whether filtered reference samples are used.

12. The decoder of claim 11, wherein the intra prediction parameters comprise one or more flags indicating whether reference sample smoothing or interpolation filtering is enabled or activated.

13. The decoder of claim 8, wherein, based on the selected buffer being the first buffer, the instructions further cause the decoder to:
determine whether interpolation filtering is activated for the IPM; and
generate the prediction block based on one of:
the unfiltered samples of the first buffer when the interpolation filtering is determined to not be activated; and
interpolated unfiltered samples of the first buffer when the interpolation filtering is determined to be activated.

14. The decoder of claim 8, wherein the plurality of prediction blocks are blended with a plurality of respective weights associated with the plurality of IPMs.

15. A non-transitory computer-readable medium comprising instructions that, when executed by one or more processors of a decoder, cause the decoder to:
generate a first buffer comprising unfiltered reference samples obtained from reference samples of a reference template of a current block;
generate a second buffer comprising filtered reference samples obtained by filtering the reference samples;
for each intra prediction mode (IPM) of a plurality of IPMs selected to generate a blended prediction block for the current block:
select, based on the IPM, a buffer from the first buffer and the second buffer; and
generate a respective prediction block for the current block based on the IPM and the selected buffer;
blend the plurality of prediction blocks to generate the blended prediction block; and
code the current block using the blended prediction block.

16. The non-transitory computer-readable medium of claim 15, wherein the filtered reference samples are obtained by applying a smoothing filter to the reference samples.

17. The non-transitory computer-readable medium of claim 15, wherein the second buffer is generated based on determining that at least one IPM of the plurality of IPMs requires filtered reference samples.

18. The non-transitory computer-readable medium of claim 15, wherein the buffer is selected based on intra prediction parameters associated with the IPM, the intra prediction parameters indicating whether filtered reference samples are used.

19. The non-transitory computer-readable medium of claim 15, wherein the intra prediction parameters comprise one or more flags indicating whether reference sample smoothing or interpolation filtering is enabled or activated.

20. The non-transitory computer-readable medium of claim 15, wherein, based on the selected buffer being the first buffer, the instructions further cause the decoder to:
determine whether interpolation filtering is activated for the IPM; and
generate the prediction block based on one of:
the unfiltered samples of the first buffer when the interpolation filtering is determined to not be activated; and
interpolated unfiltered samples of the first buffer when the interpolation filtering is determined to be activated.
